(19) United States
(12) Patent Application Publication
(10) Pub. No.: US 2009/0326216 A1
(43) Pub. Date: Dec. 31, 2009

(54) PROCESS FOR ACYLATING CELLULOSE

(75) Inventors: Veit Stegmann, Mannheim (DE); Klemens Massonne, Bad Duerkheim (DE); Giovanni D'andola, Heidelberg (DE); Werner Mormann, Siegen (DE); Markus Wezstein, Kirchhundem (DE); Wei Leng, Siegen (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: Basf Se, Ludwigshafen (DE)

(21) Appl. No.: 12/305,017

(22) PCT Filed: Jun. 4, 2007
(86) PCT No.: PCT/EP2007/055445

§ 371 Date: Dec. 16, 2008

(30) Foreign Application Priority Data
Jun. 16, 2006 (DE) 102006028165.9

(51) Int. Cl. C08B 1/00; C08B 37/00

(52) U.S. Cl. 536/56; 536/124

(57) ABSTRACT

The present invention describes a process for acylating polysaccharides, oligosaccharides or disaccharides or derivatives thereof by dissolving these in an ionic liquid and reacting them with a ketene, and also novel acylated polysaccharides, oligosaccharides or disaccharides or derivatives thereof.

The present invention describes a process for acylating cellulose by reacting cellulose with a ketene or a diketene in an ionic liquid.

Cellulose is the most important renewable raw material and represents an important starting material for, for example, the textile, paper and nonwovens industries. It also serves as raw material for derivatives and modifications of cellulose, including cellulose ethers such as methylcellulose and carboxymethylcellulose, cellulose esters based on organic acids, e.g. cellulose acetate, cellulose butyrate, and cellulose esters based on inorganic acids, e.g. cellulose nitrate, and others. These derivatives and modifications have many uses, for example in the textile, food, building and surface coatings industries. There is particular interest here in cellulose acetate.

In the industrial preparation of cellulose acetate, cotton linters or processed wood pulp are/is reacted with acetic anhydride in the presence of sulfuric acid or perchloric acid as catalyst. An appreciable decrease in the chain length of the cellulose molecule occurs here. This effect is attributed to hydrolytic cleavage of the glycosidic bonds as a consequence of the strongly acidic reaction conditions. Furthermore, the cellulose acetate obtained in this way has a degree of substitution (DS) of 3 (=cellulose triacetate). However, a DS of about 2.5 is necessary for spinning. Cellulose triacetate is therefore subjected to a partial deacylation.

Furthermore, U.S. Pat. No. 1,990,483 describes the preparation of mixed cellulose esters, in which, for example, cellulose is mixed with propionic acid comprising small amounts of sulfuric acid and ketene (CH₂CO) is passed into the reaction mixture. To set the desired DS, the cellulose acetate/propionate obtained in this way can be subjected to a conventional deacylation.

The abovementioned methods thus have various disadvantages. Thus, acylated celluloses having a DS of less than 3 cannot be prepared directly. Furthermore, a reduction in the DP (degree of polymerization) compared to the cellulose used can occur. There is therefore a need to provide processes for the targeted preparation of acylated celluloses having a defined DS.

We have now found a process for preparing acylated celluloses having a defined DS by dissolving cellulose in an ionic liquid and treating it with a ketene or a diketene. Furthermore, novel acylated celluloses have been found.

For the purposes of the present invention, ionic liquids are preferably

(A) salts of the general formula (I)

[A]ₙ⁺[Y]ⁿ⁻ (I),
where n is 1, 2, 3 or 4, [A]⁺ is a quaternary ammonium cation, an oxonium cation, a sulfonium cation or a phosphonium cation and [Y]ⁿ⁻ is a monovalent, divalent, trivalent or tetravalent anion;

(B) mixed salts of the general formulae (II)

[A¹]⁺[A²]⁺[Y]ⁿ⁻ (IIa),
where n=2;

[A¹]⁺[A²]⁺[A³]⁺[Y]ⁿ⁻ (IIb),
where n=3; or

[A¹]⁺[A²]⁺[A³]⁺[A⁴]⁺[Y]ⁿ⁻ (IIc),
where n=4,
where [A¹]⁺, [A²]⁺, [A³]⁺ and [A⁴]⁺ are selected independently from among the groups mentioned for [A]⁺ and [Y]ⁿ⁻ is as defined under (A).

The ionic liquids preferably have a melting point of less than 180° C. The melting point is particularly preferably in the range from −50° C. to 150° C., in particular in the range from −20° C. to 120° C. and extraordinarily preferably below 100° C.

The ionic liquids used according to the invention are organic compounds, i.e. at least one cation or anion of the ionic liquid comprises an organic radical.

Compounds suitable for the formation of the cation [A]⁺ of ionic liquids are known, for example, from DE 102 02 838 A1. Thus, such compounds can comprise oxygen, phosphorus, sulfur or in particular nitrogen atoms, for example at least one nitrogen atom, preferably from 1 to 10 nitrogen atoms, particularly preferably from 1 to 5 nitrogen atoms, very particularly preferably from 1 to 3 nitrogen atoms and in particular 1 or 2 nitrogen atoms. If appropriate, further heteroatoms such as oxygen, sulfur or phosphorus atoms can also be comprised. The nitrogen atom is a suitable carrier of the positive charge in the cation of the ionic liquid, from which a proton or an alkyl radical can then go over in equilibrium to the anion to produce an electrically neutral molecule.

If the nitrogen atom is the carrier of the positive charge in the cation of the ionic liquid, a cation can firstly be produced by quaternization of the nitrogen atom of, for instance, an amine or nitrogen heterocycle in the synthesis of the ionic liquids. Quaternization can be effected by alkylation of the nitrogen atom. Depending on the alkylation reagent used, salts having different anions are obtained. In cases in which it is not possible to form the desired anion in the quaternization itself, this can be brought about in a further step of the synthesis. Starting from, for example, an ammonium halide, the halide can be reacted with a Lewis acid, forming a complex anion from the halide and Lewis acid. As an alternative, replacement of a halide ion by the desired anion is possible. This can be achieved by addition of a metal salt with precipitation of the metal halide formed, by means of an ion exchanger or by displacement of the halide ion by a strong acid (with liberation of the hydrogen halide). Suitable methods are described, for example, in Angew. Chem. 2000,112, pp. 3926-3945, and the references cited therein.

Suitable alkyl radicals by means of which the nitrogen atom in the amines or nitrogen heterocycles can, for example, be quaternized are C₁-C₁₈-alkyl, preferably C₁-C₁₀-alkyl, particularly preferably C₁-C₆-alkyl and very particularly preferably methyl. The alkyl group can be unsubstituted or have one or more identical or different substituents.

Preference is given to compounds which comprise at least one five- or six-membered heterocycle, in particular a five-membered heterocycle, which has at least one nitrogen atom and also, if appropriate, an oxygen or sulfur atom. Particular preference is likewise given to compounds which comprise at least one five- or six-membered heterocycle which has one, two or three nitrogen atoms and a sulfur or oxygen atom, very particularly preferably compounds having two nitrogen atoms. Further preference is given to aromatic heterocycles.

Particularly preferred compounds have a molecular weight below 1000 g/mol, very particularly preferably below 500 g/mol and in particular below 350 g/mol.

Furthermore, preference is given to cations selected from among the compounds of the formulae (IIIa) to (IIIw),

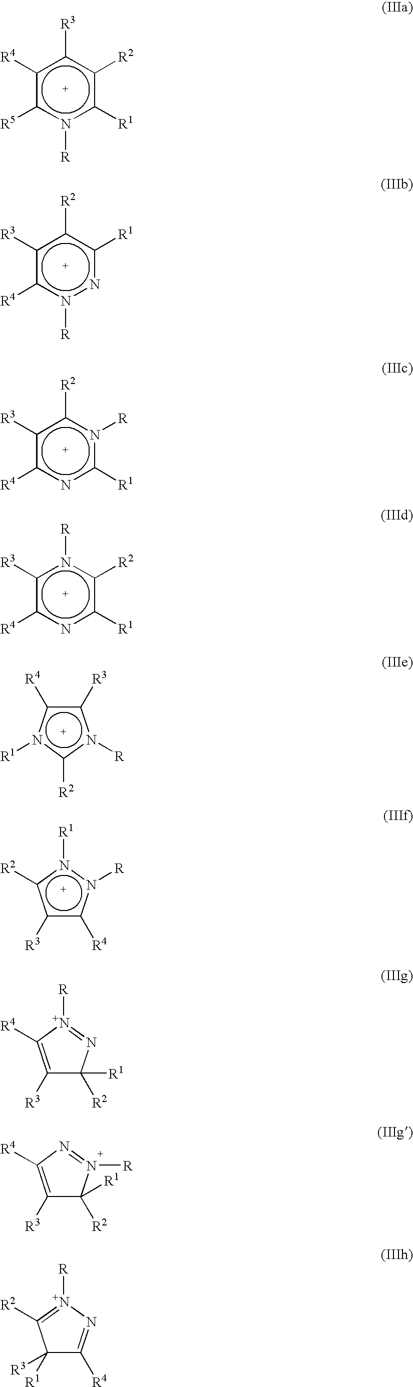

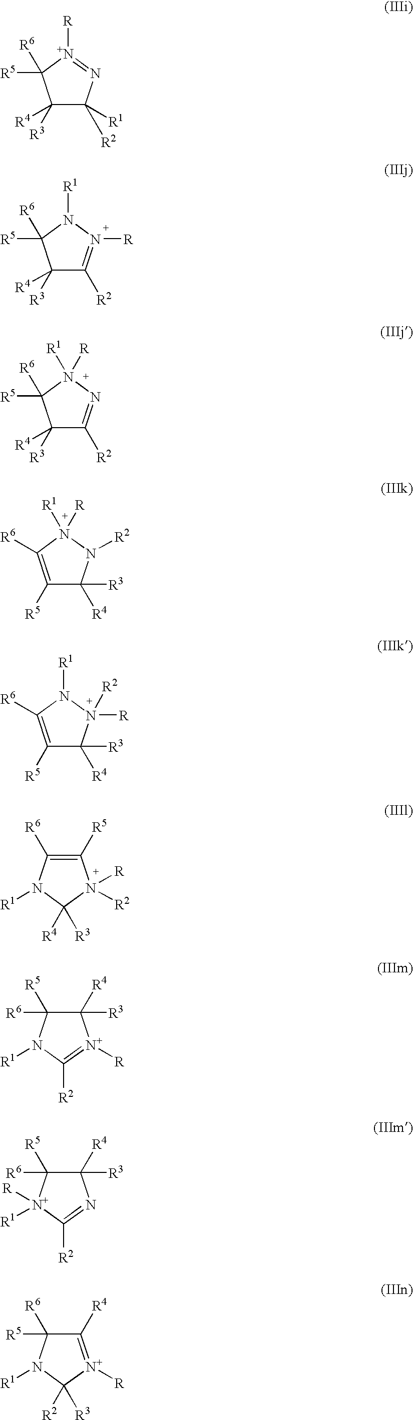

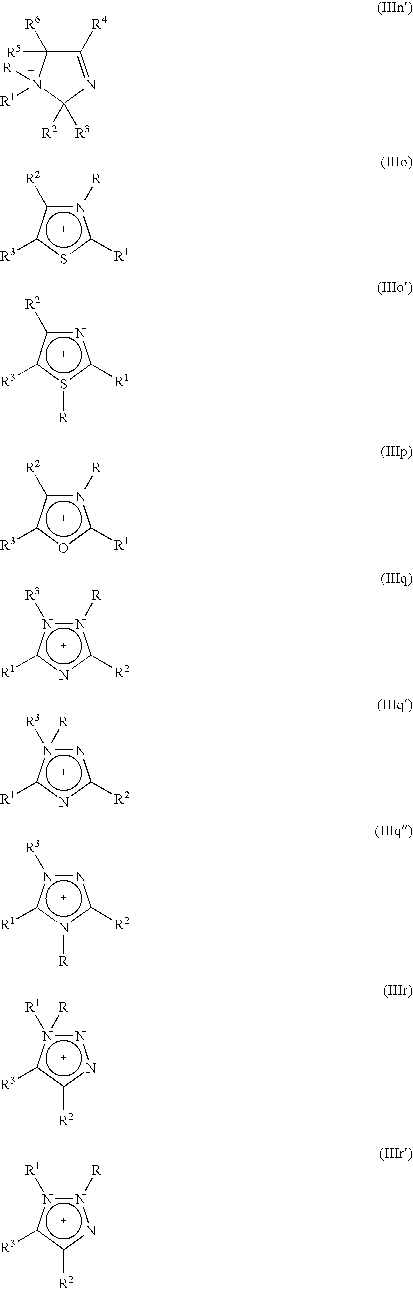

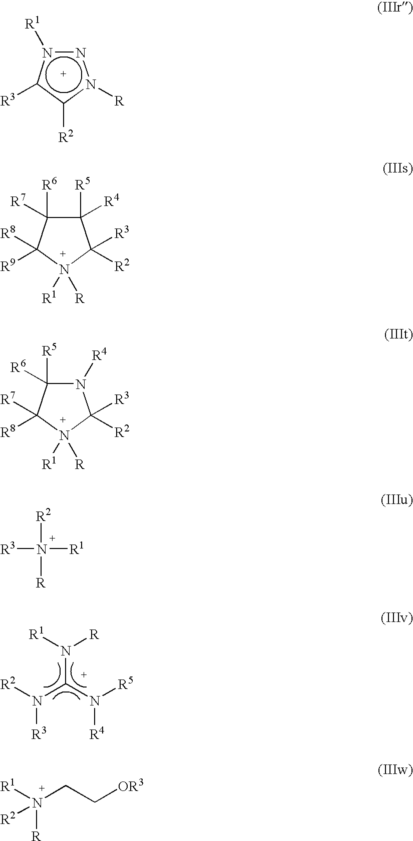

and oligomers comprising these structures.

Further suitable cations are compounds of the general formulae (IIIx) and (IIIy)

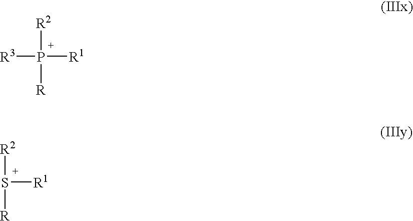

and oligomers comprising these structures.

In the abovementioned formulae (IIIa) to (IIIy),
the radical R is hydrogen or a carbon-comprising organic, saturated or unsaturated, acyclic or cyclic, aliphatic, aromatic or araliphatic radical which has from 1 to 20 carbon atoms and may be unsubstituted or be interrupted or substituted by from 1 to 5 heteroatoms or functional groups; and
the radicals R¹ to R⁹ are each, independently of one another, hydrogen, a sulfo group or a carbon-comprising organic, saturated or unsaturated, acyclic or cyclic, aliphatic, aromatic or araliphatic radical which has from 1 to 20 carbon atoms and may be unsubstituted or be interrupted or substituted by from 1 to 5 heteroatoms or functional groups, where the radicals R¹ to R⁹ which are bound to a carbon atom (and not to a heteroatom) in the formulae (III) mentioned above are additionally able to be halogen or a functional group; or
two adjacent radicals from the group consisting of R¹ to R⁹ may together also form a divalent, carbon-comprising organic, saturated or unsaturated, acyclic or cyclic, aliphatic, aromatic or araliphatic radical which has from 1 to 30 carbon atoms and may be unsubstituted or be interrupted or substituted by from 1 to 5 heteroatoms or functional groups.

In the definition of the radicals R and R¹ to R⁹, possible heteroatoms are in principle all heteroatoms which are able to formally replace a —CH₂— group, a —CH═ group, a —C≡ group or a ═C═ group. If the carbon-comprising radical comprises heteroatoms, then oxygen, nitrogen, sulfur, phosphorus and silicon are preferred. Preferred groups are, in particular, —O—, —S—, —SO—, —SO₂—, —NR′—, —N═, —PR′—, —PR′₃ and —SiR′₂—, where the radicals R′ are the remaining part of the carbon-comprising radical. In the cases in which the radicals R¹ to R⁹ are bound to a carbon atom (and not a heteroatom) in the abovementioned formulae (III), they can also be bound directly via the heteroatom.

Suitable functional groups are in principle all functional groups which can be bound to a carbon atom or a heteroatom. Suitable examples are —OH (hydroxy), ═O (in particular as carbonyl group), —NH₂ (amino), —NHR′, —NR₂′, ═NH (imino), ═NR′, —COOH (carboxy), —CONH₂ (carboxamide), —SO₃H (sulfo), and —CN (cyano). Functional groups and heteroatoms can also be directly adjacent, so that combinations of a plurality of adjacent atoms, for instance —O— (ether), —S— (thioether), —COO— (ester), —CONH— (secondary amide) or —CONR′— (tertiary amide), are also comprised, for example di-(C₁-C₄-alkyl)amino, C₁-C₄-alkyloxycarbonyl or C₁-C₄-alkyloxy. The radicals R′ are the remaining part of the carbon-comprising radical.

As halogens, mention may be made of fluorine, chlorine, bromine and iodine.

The radical R is preferably
unbranched or branched C₁-C₁₈-alkyl which may be unsubstituted or substituted by one or more hydroxy, halogen, phenyl, cyano, C₁-C₆-alkoxycarbonyl and/or SO₃H and has a total of from 1 to 20 carbon atoms, for example methyl, ethyl, 1-propyl, 2-propyl, 1-butyl, 2-butyl, 2-methyl-1-propyl, 2-methyl-2-propyl, 1-pentyl, 2-pentyl, 3-pentyl, 2-methyl-1-butyl, 3-methyl-1-butyl, 2-methyl-2-butyl, 3-methyl-2-butyl, 2,2-dimethyl-1-propyl, 1-hexyl, 2-hexyl, 3-hexyl, 2-methyl-1-pentyl, 3-methyl-1-pentyl, 4-methyl-1-pentyl, 2-methyl-2-pentyl, 3-methyl-2-pentyl, 4-methyl-2-pentyl, 2-methyl-3-pentyl, 3-methyl-3-pentyl, 2,2-dimethyl-1-butyl, 2,3-dimethyl-1-butyl, 3,3-dimethyl-1-butyl, 2-ethyl-1-butyl, 2,3-dimethyl-2-butyl, 3,3-dimethyl-2-butyl, 1-heptyl, 1-octyl, 1-nonyl, 1-decyl, 1-undecyl, 1-dodecyl, 1-tetradecyl, 1-hexadecyl, 1-octadecyl, 2-hydroxyethyl, benzyl, 3-phenylpropyl, 2-cyanoethyl, 2-(methoxycarbonyl)ethyl, 2-(ethoxycarbonyl)ethyl, 2-(n-butoxycarbonyl)ethyl, trifluoromethyl, difluoromethyl, fluoromethyl, pentafluoroethyl, heptafluoropropyl, heptafluoroisopropyl, nonafluorobutyl, nonafluoroisobutyl, undecylfluoropentyl, undecylfluoroisopentyl, 6-hydroxyhexyl and propylsulfonic acid;
glycols, butylene glycols and oligomers thereof having from 1 to 100 units, with all the above groups bearing hydrogen or a C₁-C₈-alkyl radical as end group, for example R^{A}O—(CHR^{B}—CH₂—O)ₘ—CHR^{B}—CH₂— or R^{A}O—(CH₂CH₂CH₂CH₂O)ₘ—CH₂CH₂CH₂CH₂— where R^{A} and R^{B} are each preferably hydrogen, methyl or ethyl and m is preferably 0 to 3, in particular 3-oxabutyl, 3-oxapentyl, 3,6-dioxaheptyl, 3,6-dioxaoctyl, 3,6,9-trioxadecyl, 3,6,9-trioxaundecyl, 3,6,9,12-tetraoxatridecyl and 3,6,9,12-tetraoxatetradecyl;
vinyl;
1-propen-1-yl, 1-propen-2-yl and 1-propen-3-yl; and
N,N-di-C₁-C₆-alkylamino such as N,N-dimethylamino and N,N-diethylamino.

The radical R is particularly preferably unbranched and unsubstituted C₁-C₁₈-alkyl, such as methyl, ethyl, 1-propyl, 1-butyl, 1-pentyl, 1-hexyl, 1-heptyl, 1-octyl, 1-decyl, 1-dodecyl, 1-tetradecyl, 1-hexadecyl, 1-octadecyl, 1-propen-3-yl, in particular methyl, ethyl, 1-butyl and 1-octyl, or CH₃O—(CH₂CH₂O)ₘ—CH₂CH₂— and CH₃CH₂O—(CH₂CH₂O)ₘ—CH₂CH₂— where m is 0 to 3.

Preference is given to the radicals R¹ to R⁹ each being, independently of one another,
hydrogen;
halogen;
a functional group;
C₁-C₁₈-alkyl which may optionally be substituted by functional groups, aryl, alkyl, aryloxy, alkyloxy, halogen, heteroatoms and/or heterocycles and/or be interrupted by one or more oxygen and/or sulfur atoms and/or one or more substituted or unsubstituted imino groups;
C₂-C₁₈-alkenyl which may optionally be substituted by functional groups, aryl, alkyl, aryloxy, alkyloxy, halogen, heteroatoms and/or heterocycles and/or be interrupted by one or more oxygen and/or sulfur atoms and/or one or more substituted or unsubstituted imino groups;
C₆-C₁₂-aryl which may optionally be substituted by functional groups, aryl, alkyl, aryloxy, alkyloxy, halogen, heteroatoms and/or heterocycles;
C₅-C₁₂-cycloalkyl which may optionally be substituted by functional groups, aryl, alkyl, aryloxy, alkyloxy, halogen, heteroatoms and/or heterocycles;
C₅-C₁₂-cycloalkenyl which may optionally be substituted by functional groups, aryl, alkyl, aryloxy, alkyloxy, halogen, heteroatoms and/or heterocycles; or
a five- or six-membered, oxygen-, nitrogen- and/or sulfur-comprising heterocycle which may optionally be substituted by functional groups, aryl, alkyl, aryloxy, alkyloxy, halogen, heteroatoms and/or heterocycles; or

two adjacent radicals together form
an unsaturated, saturated or aromatic ring which may optionally be substituted by functional groups, aryl, alkyl, aryloxy, alkyloxy, halogen, heteroatoms and/or heterocycles and may optionally be interrupted by one or more oxygen and/or sulfur atoms and/or one or more substituted or unsubstituted imino groups.

C₁-C₁₈-alkyl which may optionally be substituted by functional groups, aryl, alkyl, aryloxy, alkyloxy, halogen, heteroatoms and/or heterocycles is preferably methyl, ethyl, 1-propyl, 2-propyl, 1-butyl, 2-butyl, 2-methyl-1-propyl(isobutyl), 2-methyl-2-propyl(tert-butyl), 1-pentyl, 2-pentyl, 3-pentyl, 2-methyl-1-butyl, 3-methyl-1-butyl, 2-methyl-2-butyl, 3-methyl-2-butyl, 2,2-dimethyl-1-propyl, 1-hexyl, 2-hexyl, 3-hexyl, 2-methyl-1-pentyl, 3-methyl-1-pentyl, 4-methyl-1-pentyl, 2-methyl-2-pentyl, 3-methyl-2-pentyl, 4-methyl-2-pentyl, 2-methyl-3-pentyl, 3-methyl-3-pentyl, 2,2-dimethyl-l-butyl, 2,3-dimethyl-1-butyl, 3,3-dimethyl-1-butyl, 2-ethyl-1-butyl, 2,3-dimethyl-2-butyl, 3,3-dimethyl-2-butyl, heptyl, octyl, 2-ethylhexyl, 2,4,4-trimethylpentyl, 1,1,3,3-tetramethylbutyl, 1-nonyl, 1-decyl, 1-undecyl, 1-dodecyl, 1-tridecyl, 1-tetradecyl, 1-pentadecyl, 1-hexadecyl, 1-heptadecyl, 1-octadecyl, cyclopentylmethyl, 2-cyclopentylethyl, 3-cyclopentylpropyl, cyclohexylmethyl, 2-cyclohexylethyl, 3-cyclohexylpropyl, benzyl(phenylmethyl), diphenylmethyl(benzhydryl), triphenylmethyl, 1-phenylethyl, 2-phenylethyl, 3-phenylpropyl, α,α-dimethylbenzyl, p-tolylmethyl, 1-(p-butylphenyl)ethyl, p-chlorobenzyl, 2,4-dichlorobenzyl, p-methoxybenzyl, m-ethoxybenzyl, 2-cyanoethyl, 2-cyanopropyl, 2-methoxycarbonylethyl, 2-ethoxy-carbonylethyl, 2-butoxycarbonylpropyl, 1,2-di(methoxycarbonyl)ethyl, methoxy, ethoxy, formyl, 1,3-dioxolan-2-yl, 1,3-dioxan-2-yl, 2-methyl-1,3-dioxolan-2-yl, 4-methyl-1,3-dioxolan-2-yl, 2-hydroxyethyl, 2-hydroxypropyl, 3-hydroxypropyl, 4-hydroxybutyl, 6-hydroxyhexyl, 2-aminoethyl, 2-aminopropyl, 3-aminopropyl, 4-aminobutyl, 6-aminohexyl, 2-methylaminoethyl, 2-methylaminopropyl, 3-methylaminopropyl, 4-methylaminobutyl, 6-methylaminohexyl, 2-dimethylaminoethyl, 2-dimethylaminopropyl, 3-dimethylaminopropyl, 4-dimethylaminobutyl, 6-dimethylaminohexyl, 2-hydroxy-2,2-dimethylethyl, 2-phenoxyethyl, 2-phenoxypropyl, 3-phenoxypropyl, 4-phenoxybutyl, 6-phenoxyhexyl, 2-methoxyethyl, 2-methoxypropyl, 3-methoxypropyl, 4-methoxybutyl, 6-methoxyhexyl, 2-ethoxyethyl, 2-ethoxypropyl, 3-ethoxypropyl, 4-ethoxybutyl, 6-ethoxyhexyl, acetyl, CₘF_{2(m-a)+(1-b)}H_{2a+b} where m is from 1 to 30, 0≦a≦m and b=0 or 1 (for example CF₃, C₂F₅, CH₂CH₂—C₍ₘ₋₂₎F₂₍ₘ₋₂₎₊₁, C₆F₁₃, C₈F₁₇, C₁₀F₂₁, C₁₂F₂₅), chloromethyl, 2-chloroethyl, trichloromethyl, 1,1-dimethyl-2-chloroethyl, methoxymethyl, 2-butoxyethyl, diethoxymethyl, diethoxyethyl, 2-isopropoxyethyl, 2-butoxypropyl, 2-octyloxyethyl, 2-methoxyisopropyl, 2-(methoxycarbonyl)ethyl, 2-(ethoxycarbonyl)ethyl, 2-(n-butoxycarbonyl)ethyl, butylthiomethyl, 2-dodecylthioethyl, 2-phenylthioethyl, 5-hydroxy-3-oxapentyl, 8-hydroxy-3,6-dioxaoctyl, 11-hydroxy-3,6,9-trioxaundecyl, 7-hydroxy-4-oxaheptyl, 11-hydroxy-4,8-dioxaundecyl, 15-hydroxy-4,8,12-trioxapentadecyl, 9-hydroxy-5-oxanonyl, 14-hydroxy-5,10-dioxatetradecyl, 5-methoxy-3-oxapentyl, 8-methoxy-3,6-dioxaoctyl, 11-methoxy-3,6,9-trioxaundecyl, 7-methoxy-4-oxaheptyl, 11-methoxy-4,8-dioxaundecyl, 15-methoxy-4,8,12-trioxapentadecyl, 9-methoxy-5-oxanonyl, 14-methoxy-5,10-dioxatetradecyl, 5-ethoxy-3-oxapentyl, 8-ethoxy-3,6-dioxaoctyl, 11-ethoxy-3,6,9-trioxaundecyl, 7-ethoxy-4-oxaheptyl, 11-ethoxy-4,8-dioxaundecyl, 15-ethoxy-4,8,12-trioxapentadecyl, 9-ethoxy-5-oxanonyl or 14-ethoxy-5,10-oxatetradecyl.

C₂-C₁₈-alkenyl which may optionally be substituted by functional groups, aryl, alkyl, aryloxy, alkyloxy, halogen, heteroatoms and/or heterocycles and/or be interrupted by one or more oxygen and/or sulfur atoms and/or one or more substituted or unsubstituted imino groups is preferably vinyl, 2-propenyl, 3-butenyl, cis-2-butenyl, trans-2-butenyl or CₘF_{2(m-a)-(1-b)}H_{2a-b} where m≦30, 0≦a≦m and b=0 or 1.

C₆-C₁₂-aryl which may optionally be substituted by functional groups, aryl, alkyl, aryloxy, alkyloxy, halogen, heteroatoms and/or heterocycles is preferably phenyl, tolyl, xylyl, α-naphthyl, β-naphthyl, 4-diphenylyl, chlorophenyl, dichlorophenyl, trichlorophenyl, difluorophenyl, methylphenyl, dimethylphenyl, trimethylphenyl, ethylphenyl, diethylphenyl, isopropylphenyl, tert-butylphenyl, dodecylphenyl, methoxyphenyl, dimethoxyphenyl, ethoxyphenyl, hexyloxyphenyl, methylnaphthyl, isopropylnaphthyl, chloronaphthyl, ethoxynaphthyl, 2,6-dimethylphenyl, 2,4,6-trimethylphenyl, 2,6-dimethoxyphenyl, 2,6-dichlorophenyl, 4-bromophenyl, 2-nitrophenyl, 4-nitrophenyl, 2,4-dinitrophenyl, 2,6-dinitrophenyl, 4-dimethylaminophenyl, 4-acetylphenyl, methoxyethylphenyl, ethoxymethylphenyl, methylthiophenyl, isopropylthiophenyl or tert-butylthiophenyl or C₆F₍₅₋ₐ₎Hₐ where 0≦a≦5.

C₅-C₁₂-cycloalkyl which may optionally be substituted by functional groups, aryl, alkyl, aryloxy, alkyloxy, halogen, heteroatoms and/or heterocycles is preferably cyclopentyl, cyclohexyl, cyclooctyl, cyclododecyl, methylcyclopentyl, dimethylcyclopentyl, methylcyclohexyl, dimethylcyclohexyl, diethylcyclohexyl, butylcyclohexyl, methoxycyclohexyl, dimethoxycyclohexyl, diethoxycyclohexyl, butylthiocyclohexyl, chlorocyclohexyl, dichlorocyclohexyl, dichlorocyclopentyl, CₘF_{2(m-a)-(1-b)}H_{2a-b} where m≦30, 0≦a≦m and b=0 or 1, or a saturated or unsaturated bicyclic system such as norbornyl or norbornenyl.

C₅-C₁₂-cycloalkenyl which may optionally be substituted by functional groups, aryl, alkyl, aryloxy, alkyloxy, halogen, heteroatoms and/or heterocycles is preferably 3-cyclopentenyl, 2-cyclohexenyl, 3-cyclohexenyl, 2,5-cyclohexadienyl or CₙF_{2(m-a)-3(1-b)}H_{2a-3b} where m≦30, 0≦a≦m and b=0 or 1.

A five- or six-membered, oxygen-, nitrogen- and/or sulfur-comprising heterocycle which may optionally be substituted by functional groups, aryl, alkyl, aryloxy, alkyloxy, halogen, heteroatoms and/or heterocycles is preferably furyl, thiophenyl, pyrryl, pyridyl, indolyl, benzoxazolyl, dioxolyl, dioxyl, benzimidazolyl, benzthiazolyl, dimethylpyridyl, methylquinolyl, dimethylpyrryl, methoxyfuryl, dimethoxypyridyl or difluoropyridyl.

If two adjacent radicals together form an unsaturated, saturated or aromatic ring which may optionally be substituted by functional groups, aryl, alkyl, aryloxy, alkyloxy, halogen, heteroatoms and/or heterocycles and may optionally be interrupted by one or more oxygen and/or sulfur atoms and/or one or more substituted or unsubstituted imino groups, they preferably form 1,3-propylene, 1,4-butylene, 1,5-pentylene, 2-oxa-1,3-propylene, 1-oxa-1,3-propylene, 2-oxa-1,3-propylene, 1-oxa-1,3-propenylene, 3-oxa-1,5-pentylene, 1-aza-1,3-propenylene, 1-C₁-C₄-alkyl-1-aza-1,3-propenylene, 1,4-buta-1,3-dienylene, 1-aza-1,4-buta-1,3-dienylene or 2-aza-1,4-buta-1,3-dienylene.

If the abovementioned radicals comprise oxygen and/or sulfur atoms and/or substituted or unsubstituted imino groups, the number of oxygen and/or sulfur atoms and/or imino groups is not subject to any restrictions. In general, there will be no more than 5 in the radical, preferably no more than 4 and very particularly preferably no more than 3.

If the abovementioned radicals comprise heteroatoms, there is generally at least one carbon atom, preferably at least two carbon atoms, between any two heteroatoms.

Particular preference is given to the radicals R¹ to R⁹ each being, independently of one another,
hydrogen;
unbranched or branched C₁-C₁₈-alkyl which may be unsubstituted or substituted by one or more hydroxy, halogen, phenyl, cyano, C₁-C₆-alkoxycarbonyl and/or SO₃H groups and has a total of from 1 to 20 carbon atoms, for example methyl, ethyl, 1-propyl, 2-propyl, 1-butyl, 2-butyl, 2-methyl-1-propyl, 2-methyl-2-propyl, 1-pentyl, 2-pentyl, 3-pentyl, 2-methyl-1-butyl, 3-methyl-1-butyl, 2-methyl-2-butyl, 3-methyl-2-butyl, 2,2-dimethyl-1-propyl, 1-hexyl, 2-hexyl, 3-hexyl, 2-methyl-1-pentyl, 3-methyl-1-pentyl, 4-methyl-1-pentyl, 2-methyl-2-pentyl, 3-methyl-2-pentyl, 4-methyl-2-pentyl, 2-methyl-3-pentyl, 3-methyl-3-pentyl, 2,2-dimethyl-1-butyl, 2,3-dimethyl-1-butyl, 3,3-dimethyl-1-butyl, 2-ethyl-1-butyl, 2,3-dimethyl-2-butyl, 3,3-dimethyl-2-butyl, 1-heptyl, 1-octyl, 1-nonyl, 1-decyl, 1-undecyl, 1-dodecyl, 1-tetradecyl, 1-hexadecyl, 1-octadecyl, 2-hydroxyethyl, benzyl, 3-phenylpropyl, 2-cyanoethyl, 2-(methoxycarbonyl)ethyl, 2-(ethoxycarbonyl)ethyl, 2-(n-butoxy-carbonyl)ethyl, trifluoromethyl, difluoromethyl, fluoromethyl, pentafluoroethyl, heptafluoropropyl, heptafluoroisopropyl, nonafluorobutyl, nonafluoroisobutyl, undecylfluoropentyl, undecylfluoroisopentyl, 6-hydroxyhexyl and propylsulfonic acid;
glycols, butylene glycols and oligomers thereof having from 1 to 100 units, with all the above groups bearing a hydrogen or a C₁-C₈-alkyl radical as end group, for example R^{A}O—(CHR^{B}—CH₂—O)ₘ—CHR^{B}—CH₂— or R^{A}O—(CH₂CH₂CH₂CH₂O)ₘ—CH₂CH₂CH₂CH₂— where R^{A} and R^{B} are each preferably hydrogen, methyl or ethyl and n is preferably 0 to 3, in particular 3-oxabutyl, 3-oxapentyl, 3,6-dioxaheptyl, 3,6-dioxaoctyl, 3,6,9-trioxadecyl, 3,6,9-trioxaundecyl, 3,6,9,12-tetraoxatridecyl and 3,6,9,12-tetraoxatetradecyl;
vinyl;
1-propen-1-yl, 1-propen-2-yl and 1-propen-3-yl; and
N,N-di-C₁-C₆-alkylamino, such as N,N-dimethylamino and N,N-diethylamino.

Very particular preference is given to the radicals R¹ to R⁹ each being, independently of one another, hydrogen or C₁-C₁₈-alkyl such as methyl, ethyl, 1-butyl, 1-pentyl, 1-hexyl, 1-heptyl, 1-octyl, phenyl, 2-hydroxyethyl, 2-cyanoethyl, 2-(methoxycarbonyl)ethyl, 2-(ethoxycarbonyl)ethyl, 2-(n-butoxycarbonyl)ethyl, N,N-dimethylamino, N,N-diethylamino, chlorine or CH₃O—(CH₂CH₂O)ₘ—CH₂CH₂— and CH₃CH₂O—(CH₂CH₂O)ₘ—CH₂CH₂— where m is 0-3.

Very particularly preferred pyridinium ions (IIIa) are those in which
one of the radicals R¹ to R⁵ is methyl, ethyl or chlorine and the remaining radicals R¹ to R⁵ are each hydrogen;
R³ is dimethylamino and the remaining radicals R¹, R², R⁴ and R⁵ are each hydrogen;
all radicals R¹ to R⁵ are hydrogen;
R² is carboxy or carboxamide and the remaining radicals R¹, R², R⁴ and R⁵ are each hydrogen; or
R¹ and R² or R² and R³ are 1,4-buta-1,3-dienylene and the remaining radicals R¹, R², R⁴ and R⁵ are each hydrogen;

and in particular those in which
R¹ to R⁵ are each hydrogen; or
one of the radicals R¹ to R⁵ is methyl or ethyl and the remaining radicals R¹ to R⁵ are each hydrogen.

As very particularly preferred pyridinium ions (IIIa), mention may be made of 1-methylpyridinium, 1-ethylpyridinium, 1-(1-butyl)pyridinium, 1-(1-hexyl)pyridinium, 1-(1-octyl)pyridinium, 1-(1-hexyl)pyridinium, 1-(1-octyl)pyridinium, 1-(1-dodecyl)pyridinium, 1-(1-tetradecyl)pyridinium, 1-(1-hexadecyl)pyridinium, 1,2-dimethylpyridinium, 1-ethyl-2-methylpyridinium, 1-(1-butyl)-2-methylpyridinium, 1-(1-hexyl)-2-methylpyridinium, 1-(1-octyl)-2-methylpyridinium, 1-(1-dodecyl)-2-methylpyridinium, 1-(1-tetradecyl)-2-methylpyridinium, 1-(1-hexadecyl)-2-methylpyridinium, 1-methyl-2-ethylpyridinium, 1,2-diethylpyridinium, 1-(1-butyl)-2-ethylpyridinium, 1-(1-hexyl)-2-ethylpyridinium, 1-(1-octyl)-2-ethylpyridinium, 1-(1-dodecyl)-2-ethylpyridinium, 1-(1-tetradecyl)-2-ethylpyridinium, 1-(1-hexadecyl)-2-ethylpyridinium, 1,2-dimethyl-5-ethylpyridinium, 1,5-diethyl-2-methylpyridinium, 1-(1-butyl)-2-methyl-3-ethylpyridinium, 1-(1-hexyl)-2-methyl-3-ethylpyridinium and 1-(1-octyl)-2-methyl-3-ethylpyridinium, 1-(1-dodecyl)-2-methyl-3-ethylpyridinium, 1-(1-tetradecyl)-2-methyl-3-ethylpyridinium and 1-(1-hexadecyl)-2-methyl-3-ethylpyridinium.

Very particularly preferred pyridazinium ions (IIIb) are those in which
R¹ to R⁴ are each hydrogen; or
one of the radicals R¹ to R⁴ is methyl or ethyl and the remaining radicals R¹ to R⁴ are each hydrogen.

Very particularly preferred pyrimidinium ions (IIIc) are those in which
R¹ is hydrogen, methyl or ethyl and R² to R⁴ are each, independently of one another, hydrogen or methyl; or
R¹ is hydrogen, methyl or ethyl, R² and R⁴ are each methyl and R³ is hydrogen.

Very particularly preferred pyrazinium ions (IIId) are those in which
R¹ is hydrogen, methyl or ethyl and R² to R⁴ are each, independently of one another, hydrogen or methyl;
R¹ is hydrogen, methyl or ethyl, R² and R⁴ are each methyl and R³ is hydrogen;
R¹ to R⁴ are each methyl; or
R¹ to R⁴ are each methyl or hydrogen.

Very particularly preferred imidazolium ions (IIIe) are those in which
R¹ is hydrogen, methyl, ethyl, 1-propyl, 1-butyl, 1-pentyl, 1-hexyl, 1-octyl, 1-propen-3-yl, 2-hydroxyethyl or 2-cyanoethyl, and R² to R⁴ are each, independently of one another, hydrogen, methyl or ethyl.

As very particularly preferred imidazolium ions (IIIe), mention may be made of 1-methylimidazolium, 1-ethylimidazolium, 1-(1-butyl)imidazolium, 1-(1-octyl)imidazolium, 1-(1-dodecyl)imidazolium, 1-(1-tetradecyl)imidazolium, 1-(1-hexadecyl)imidazolium, 1,3-dimethylimidazolium, 1-ethyl-3-methylimidazolium, 1-(1-butyl)-3-methylimidazolium, 1-(1-butyl)-3-ethylimidazolium, 1-(1-hexyl)-3-methylimidazolium, 1-(1-hexyl)-3-ethylimidazolium, 1-(1-hexyl)-3-butylimidazolium, 1-(1-octyl)-3-methylimidazolium, 1-(1-octyl)-3-ethylimidazolium, 1-(1-octyl)-3-butylimidazolium, 1-(1-dodecyl)-3-methylimidazolium, 1-(1-dodecyl)-3-ethylimidazolium, 1-(1-dodecyl)-3-butylimidazolium, 1-(1-dodecyl)-3-octylimidazolium, 1-(1-tetradecyl)-3-methylimidazolium, 1-(1-tetradecyl)-3-ethylimidazolium, 1-(1-tetradecyl)-3-butylimidazolium, 1-(1-tetradecyl)-3-octylimidazolium, 1-(1-hexadecyl)-3-methylimidazolium, 1-(1-hexadecyl)-3-ethylimidazolium, 1-(1-hexadecyl)-3-butylimidazolium, 1-(1-hexadecyl)-3-octylimidazolium, 1,2-dimethylimidazolium, 1,2,3-trimethylimidazolium, 1-ethyl-2,3-dimethylimidazolium, 1-(1-butyl)-2,3-dimethylimidazolium, 1-(1-hexyl)-2,3-dimethylimidazolium, 1-(1-octyl)-2,3-dimethylimidazolium, 1,4-dimethylimidazolium, 1,3,4-trimethylimidazolium, 1,4-dimethyl-3-ethylimidazolium, 1,4-dimethyl-3-butylimidazolium, 1,4-dimethyl-3-octylimidazolium, 1,4,5-trimethylimidazolium, 1,3,4,5-tetramethylimidazolium, 1,4,5-trimethyl-3-ethylimidazolium, 1,4,5-trimethyl-3-butylimidazolium, 1,4,5-trimethyl-3-octylimidazolium and 1-(prop-1-en-3-yl)-3-methylimidazolium.

Very particularly preferred pyrazolium ions (IIIf), (IIIg) and (IIIg′) are those in which
R¹ is hydrogen, methyl or ethyl and R² to R⁴ are each, independently of one another, hydrogen or methyl.

Very particularly preferred pyrazolium ions (IIIh) are those in which
R¹ to R⁴ are each, independently of one another, hydrogen or methyl.

Very particularly preferred 1-pyrazolinium ions (IIIi) are those in which
R¹ to R⁶ are each, independently of one another, hydrogen or methyl.

Very particularly preferred 2-pyrazolinium ions (IIIj) and (IIIj′) are those in which
R¹ is hydrogen, methyl, ethyl or phenyl and R² to R⁶ are each, independently of one another, hydrogen or methyl.

Very particularly preferred 3-pyrazolinium ions (IIIk) and (IIIk′) are those in which
R¹ and R² are each, independently of one another, hydrogen, methyl, ethyl or phenyl and R³ to R⁶ are each, independently of one another, hydrogen or methyl.

Very particularly preferred imidazolinium ions (IIIl) are those in which
R¹ and R² are each, independently of one another, hydrogen, methyl, ethyl, 1-butyl or phenyl, R³ and R⁴ are each, independently of one another, hydrogen, methyl or ethyl and R⁵ and R⁶ are each, independently of one another, hydrogen or methyl.

Very particularly preferred imidazolinium ions (IIIm) and (IIIm′) are those in which
R¹ and R² are each, independently of one another, hydrogen, methyl or ethyl and R³ to R⁶ are each, independently of one another, hydrogen or methyl.

Very particularly preferred imidazolinium ions (IIIn) and (IIIn′) are those in which
R¹ to R³ are each, independently of one another, hydrogen, methyl or ethyl and R⁴ to R⁶ are each, independently of one another, hydrogen or methyl.

Very particularly preferred thiazolium ions (IIIo) and (IIIo′) and oxazolium ions (IIIp) are those in which
R¹ is hydrogen, methyl, ethyl or phenyl and R² and R³ are each, independently of one another, hydrogen or methyl.

Very particularly preferred 1,2,4-triazolium ions (IIIq), (IIIq′) and (IIIq″) are those in which
R¹ and R² are each, independently of one another, hydrogen, methyl, ethyl or phenyl and R³ is hydrogen, methyl or phenyl.

Very particularly preferred 1,2,3-triazolium ions (IIIr), (IIIr′) and (IIIr″) are those in which
R¹ is hydrogen, methyl or ethyl and R² and R³ are each, independently of one another, hydrogen or methyl or R² and R³ are together 1,4-buta-1,3-dienylene.

Very particularly preferred pyrrolidinium ions (IIIs) are those in which
R¹ is hydrogen, methyl, ethyl or phenyl and R² to R⁹ are each, independently of one another, hydrogen or methyl.

Very particularly preferred imidazolidinium ions (IIIt) are those in which
R¹ and R⁴ are each, independently of one another, hydrogen, methyl, ethyl or phenyl and R² and R³ and also R⁵ to R⁸ are each, independently of one another, hydrogen or methyl.

Very particularly preferred ammonium ions (IIIu) are those in which
R¹ to R³ are each, independently of one another, C₁-C₁₈-alkyl; or
R¹ and R² are together 1,5-pentylene or 3-oxa-1,5-pentylene and R³ is C₁-C₁₈-alkyl, 2-hydroxyethyl or 2-cyanoethyl.

As very particularly preferred ammonium ions (IIIu), mention may be made of methyltri-(1-butyl)ammonium, N,N-dimethylpiperidinium and N,N-dimethylmorpholinium.

Examples of tertiary amines from which the quaternary ammonium ions of the general formula (IIIu) are derived by quaternization with the radicals R mentioned are diethyl-n-butylamine, diethyl-tert-butylamine, diethyl-n-pentylamine, diethylhexylamine, diethyloctylamine, diethyl(2-ethylhexyl)amine, di-n-propylbutylamine, di-n-propyl-n-pentylamine, di-n-propylhexylamine, di-n-propyloctylamine, di-n-propyl(2-ethylhexyl)amine, diisopropylethylamine, diisopropyl-n-propylamine, diisopropylbutylamine, diisopropylpentylamine, diisopropylhexylamine, diisopropyloctylamine, diisopropyl(2-ethylhexyl)amine, di-n-butylethylamine, di-n-butyl-n-propylamine, di-n-butyl-n-pentylamine, di-n-butylhexylamine, di-n-butyloctylamine, di-n-butyl(2-ethylhexyl)amine, N-n-butylpyrrolidine, N-sec-butylpyrrolidine, N-tert-butylpyrrolidine, N-n-pentylpyrrolidine, N,N-dimethylcyclohexylamine, N,N-diethylcyclohexylamine, N,N-di-n-butylcyclohexylamine, N-n-propylpiperidine, N-isopropylpiperidine, N-n-butylpiperidine, N-sec-butylpiperidine, N-tert-butylpiperidine, N-n-pentylpiperidine, N-n-butylmorpholine, N-sec-butylmorpholine, N-tert-butylmorpholine, N-n-pentylmorpholine, N-benzyl-N-ethylaniline, N-benzyl-N-n-propylaniline, N-benzyl-N-isopropylaniline, N-benzyl-N-n-butylaniline, N,N-dimethyl-p-toluidine, N,N-diethyl-p-toluidine, N,N-di-n-butyl-p-toluidine, diethylbenzylamine, di-n-propylbenzylamine, di-n-butylbenzylamine, diethylphenylamine, di-n-propylphenylamine and di-n-butyiphenylamine.

Preferred quaternary ammonium ions of the general formula (IIIu) are those which can be derived from the following tertiary amines by quaternization by means of the radicals R mentioned, e.g. diisopropylethylamine, diethyl-tert-butylamine, diisopropylbutylamine, di-n-butyl-n-pentylamine, N,N-di-n-butylcyclohexylamine and tertiary amines derived from pentyl isomers.

Particularly preferred tertiary amines are di-n-butyl-n-pentylamine and tertiary amines derived from pentyl isomers. A further preferred tertiary amine which has three identical radicals is triallylamine.

Very particularly preferred guanidinium ions (IIIv) are those in which
R¹ to R⁵ are each methyl.

As a very particularly preferred guanidinium ion (IIIv) mention may be made of N,N,N′,N′,N″,N″-hexamethylguanidinium.

Very particularly preferred cholinium ions (IIIw) are those in which
R¹ and R² are each, independently of one another, methyl, ethyl, 1-butyl or 1-octyl and R³ is hydrogen, methyl, ethyl, acetyl, —SO₂OH or —PO(OH)₂;
R¹ is methyl, ethyl, 1-butyl or 1-octyl, R² is a —CH₂—CH₂—OR⁴ group and R³ and R⁴ are each, independently of one another, hydrogen, methyl, ethyl, acetyl, —SO₂OH or —PO(OH)₂; or
R¹ is a —CH₂—CH₂—OR⁴ group, R² is a —CH₂—CH₂—OR⁵ group and R³ to R⁵ are each, independently of one another, hydrogen, methyl, ethyl, acetyl, —SO₂OH or —PO(OH)₂.

Particularly preferred cholinium ions (IIIw) are those in which R³ is selected from among hydrogen, methyl, ethyl, acetyl, 5-methoxy-3-oxapentyl, 8-methoxy-3,6-dioxaoctyl, 11-methoxy-3,6,9-trioxaundecyl, 7-methoxy-4-oxaheptyl, 11-methoxy-4,8-dioxaundecyl, 15-methoxy-4,8,12-trioxapentadecyl, 9-methoxy-5-oxanonyl, 14-methoxy-5,10-oxatetradecyl, 5-ethoxy-3-oxapentyl, 8-ethoxy-3,6-dioxaoctyl, 11-ethoxy-3,6,9-trioxaundecyl, 7-ethoxy-4-oxaheptyl, 11-ethoxy-4,8-dioxaundecyl, 15-ethoxy-4,8,12-trioxapentadecyl, 9-ethoxy-5-oxanonyl and 14-ethoxy-5,10-oxatetradecyl.

Very particularly preferred phosphonium ions (IIIx) are those in which
R¹ to R³ are each, independently of one another, C₁-C₁₈-alkyl, in particular butyl, isobutyl, 1-hexyl or 1-octyl.

Among the abovementioned heterocyclic cations, preference is given to the pyridinium ions, pyrazolinium ions, pyrazolium ions and the imidazolinium ions and the imidazolium ions. Preference is also given to ammonium ions.

Particular preference is given to 1-methylpyridinium, 1-ethylpyridinium, 1-(1-butyl)-pyridinium, 1-(1-hexyl)pyridinium, 1-(1-octyl)pyridinium, 1-(1-hexyl)pyridinium, 1-(1-octyl)pyridinium, 1-(1-dodecyl)pyridinium, 1-(1-tetradecyl)pyridinium, 1-(1-hexadecyl)pyridinium, 1,2-dimethylpyridinium, 1-ethyl-2-methylpyridinium, 1-(1-butyl)-2-methylpyridinium, 1-(1-hexyl)-2-methylpyridinium, 1-(1-octyl)-2-methylpyridinium, 1-(1-dodecyl)-2-methylpyridinium, 1-(1-tetradecyl)-2-methylpyridinium, 1-(1-hexadecyl)-2-methylpyridinium, 1-methyl-2-ethylpyridinium, 1,2-diethylpyridinium, 1-(1-butyl)-2-ethylpyridinium, 1-(1-hexyl)-2-ethylpyridinium, 1-(1-octyl)-2-ethylpyridinium, 1-(1-dodecyl)-2-ethylpyridinium, 1-(1-tetradecyl)-2-ethylpyridinium, 1-(1-hexadecyl)-2-ethylpyridinium, 1,2-dimethyl-5-ethylpyridinium, 1,5-diethyl-2-methylpyridinium, 1-(1-butyl)-2-methyl-3-ethylpyridinium, 1-(1-hexyl)-2-methyl-3-ethylpyridinium, 1-(1-octyl)-2-methyl-3-ethylpyridinium, 1-(1-dodecyl)-2-methyl-3-ethylpyridinium, 1-(1-tetradecyl)-2-methyl-3-ethylpyridinium, 1-(1-hexadecyl)-2-methyl-3-ethylpyridinium, 1-methylimidazolium, 1-ethylimidazolium, 1-(1-butyl)imidazolium, 1-(1-octyl)-imidazolium, 1-(1-dodecyl)imidazolium, 1-(1-tetradecyl)imidazolium, 1-(1-hexadecyl)imidazolium, 1,3-dimethylimidazolium, 1-ethyl-3-methylimidazolium, 1-(1-butyl)-3-methylimidazolium, 1-(1-hexyl)-3-methylimidazolium, 1-(1-octyl)-3-methylimidazolium, 1-(1-dodecyl)-3-methylimidazolium, 1-(1-tetradecyl)-3-methylimidazolium, 1-(1-hexadecyl)-3-methylimidazolium, 1,2-dimethylimidazolium, 1,2,3-trimethylimidazolium, 1-ethyl-2,3-dimethylimidazolium, 1-(1-butyl)-2,3-dimethylimidazolium, 1-(1-hexyl)-2,3-dimethylimidazolium and 1-(1-octyl)-2,3-dimethylimidazolium, 1,4-dimethylimidazolium, 1,3,4-trimethylimidazolium, 1,4-dimethyl-3-ethylimidazolium, 3-butylimidazolium, 1,4-dimethyl-3-octylimidazolium, 1,4,5-trimethylimidazolium, 1,3,4,5-tetramethylimidazolium, 1,4,5-trimethyl-3-ethylimidazolium, 1,4,5-trimethyl-3-butylimidazolium, 1,4,5-trimethyl-3-octylimidazolium and 1-(prop-1-en-3-yl)-3-methylimidazolium.

As anions, it is in principle possible to use all anions.

The anion [Y]ⁿ⁻ of the ionic liquid is, for example, selected from
the group of halides and halogen-comprising compounds of the formulae:

F⁻, Cl⁻, Br⁻, I⁻, BF₄⁻, PF₆⁻, CF₃SO₃⁻, (CF₃SO₃)₂N⁻, CF₃CO₂⁻, CCl₃CO₂⁻, CN⁻, SCN⁻, OCN⁻
the group of sulfates, sulfites and sulfonates of the general formulae:

SO₄²⁻, HSO₄⁻, SO₃²⁻, HSO₃⁻, R^{a}OSO₃⁻, R^{a}SO₃⁻
the group of phosphates of the general formulae

PO₄³⁻, HPO₄²⁻, H₂PO₄⁻, R^{a}PO₄²⁻, HR^{a}PO₄⁻, R^{a}R^{b}PO₄⁻
the group of phosphonates and phosphinates of the general formulae:

R^{a}HPO₃⁻, R^{a}R^{b}PO₂⁻, R^{a}R^{b}PO₃⁻
the group of phosphites of the general formulae:

PO₃³⁻, HPO₃²⁻, H₂PO₃₋, R^{a}PO₃²⁻, R^{a}HPO₃⁻, R^{a}R^{b}PO₃⁻
the group of phosphonites and phosphinites of the general formulae:

R^{a}R^{b}PO₂⁻, R^{a}HPO₂⁻, R^{a}R^{b}PO⁻, R^{a}HPO⁻
the group of carboxylic acids of the general formula:

R^{a}COO⁻
the group of borates of the general formulae:

BO₃³⁻, HBO₃²⁻, H₂BO₃⁻, R^{a}R^{b}BO₃⁻, R^{a}HBO₃⁻, R^{a}BO₃²⁻, B(OR^{a})(OR^{b})(OR^{c})(OR^{d})⁻, B(HSO₄)⁻, B(R^{a}SO₄)⁻
the group of boronates of the general formulae:

R^{a}BO₂²⁻, R^{a}R^{b}BO⁻
the group of silicates and silicic esters of the general formulae:

SiO₄⁴⁻, HSiO₄³⁻, H₂SiO₄²⁻, H₃SiO₄⁻, R^{a}SiO₄³⁻, R^{a}R^{b}SiO₄²⁻, R^{a}R^{b}R^{c}SiO₄⁻, HR^{a}SiO₄²⁻, H₂R^{a}SiO₄⁻, HR^{a}R^{b}SiO₄⁻
the group of alkylsilane and arylsilane salts of the general formulae:

R^{a}SiO₃³⁻, R^{a}R^{b}SiO₂²⁻, R^{a}R^{b}R^{c}SiO⁻, R^{a}R^{b}R^{c}SiO₃⁻, R^{a}R^{b}R^{c}SiO₂⁻, R^{a}R^{b}SiO₃²⁻
the group of carboximides, bis(sulfonyl)imides and sulfonylimides of the general formulae:

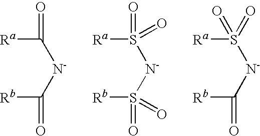

the group of methides of the general formula:

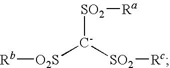

Here, R^{a}, R^{b}, R^{c} and R^{d} are each, independently of one another, hydrogen, C₁-C₃₀-alkyl, C₂-C₁₈-alkyl which may optionally be interrupted by one or more nonadjacent oxygen and/or sulfur atoms and/or one or more substituted or unsubstituted imino groups, C₆-C₁₄-aryl, C₅-C₁₂-cycloalkyl or a five- or six-membered, oxygen-, nitrogen- and/or sulfur-comprising heterocycle, where two of them may also together form an unsaturated, saturated or aromatic ring which may optionally be interrupted by one or more oxygen and/or sulfur atoms and/or one or more unsubstituted or substituted imino groups, where the radicals mentioned may each be additionally substituted by functional groups, aryl, alkyl, aryloxy, alkyloxy, halogen, heteroatoms and/or heterocycles.

Here, C₁-C₁₈-alkyl which may optionally be substituted by functional groups, aryl, alkyl, aryloxy, alkyloxy, halogen, heteroatoms and/or heterocycles is, for example, methyl, ethyl, propyl, isopropyl, n-butyl, sec-butyl, tert-butyl, pentyl, hexyl, heptyl, octyl, 2-ethylhexyl, 2,4,4-trimethylpentyl, decyl, dodecyl, tetradecyl, hetadecyl, octadecyl, 1,1-dimethylpropyl, 1,1-dimethylbutyl, 1,1,3,3-tetramethylbutyl, benzyl, 1-phenylethyl, α,α-dimethylbenzyl, benzhydryl, p-tolylmethyl, 1-(p-butylphenyl)ethyl, p-chlorobenzyl, 2,4-dichlorobenzyl, p-methoxybenzyl, m-ethoxybenzyl, 2-cyanoethyl, 2-cyanopropyl, 2-methoxycarbonylethyl, 2-ethoxycarbonylethyl, 2-butoxycarbonylpropyl, 1,2-di(methoxycarbonyl)ethyl, 2-methoxyethyl, 2-ethoxyethyl, 2-butoxyethyl, diethoxymethyl, diethoxyethyl, 1,3-dioxolan-2-yl, 1,3-dioxan-2-yl, 2-methyl-1,3-dioxolan-2-yl, 4-methyl-1,3-dioxolan-2-yl, 2-isopropoxyethyl, 2-butoxypropyl, 2-octyloxyethyl, chloromethyl, trichloromethyl, trifluoromethyl, 1,1-dimethyl-2-chloroethyl, 2-methoxyisopropyl, 2-ethoxyethyl, butylthiomethyl, 2-dodecylthioethyl, 2-phenylthioethyl, 2,2,2-trifluoroethyl, 2-hydroxyethyl, 2-hydroxypropyl, 3-hydroxypropyl, 4-hydroxybutyl, 6-hydroxyhexyl, 2-aminoethyl, 2-aminopropyl, 4-aminobutyl, 6-aminohexyl, 2-methylaminoethyl, 2-methylaminopropyl, 3-methylaminopropyl, 4-methylaminobutyl, 6-methylaminohexyl, 2-dimethylaminoethyl, 2-dimethylaminopropyl, 3-dimethylaminopropyl, 4-dimethylaminobutyl, 6-dimethylaminohexyl, 2-hydroxy-2,2-dimethylethyl, 2-phenoxyethyl, 2-phenoxypropyl, 3-phenoxypropyl, 4-phenoxybutyl, 6-phenoxyhexyl, 2-methoxyethyl, 2-methoxypropyl, 3-methoxypropyl, 4-methoxybutyl, 6-methoxyhexyl, 2-ethoxyethyl, 2-ethoxypropyl, 3-ethoxypropyl, 4-ethoxybutyl or 6-ethoxyhexyl.

C₂-C₁₈-alkyl which may optionally be interrupted by one or more nonadjacent oxygen and/or sulfur atoms and/or one or more substituted or unsubstituted imino groups is, for example, 5-hydroxy-3-oxapentyl, 8-hydroxy-3,6-dioxaoctyl, 11-hydroxy-3,6,9-trioxaundecyl, 7-hydroxy-4-oxaheptyl, 11-hydroxy-4,8-dioxaundecyl, 15-hydroxy-4,8,12-trioxapentadecyl, 9-hydroxy-5-oxanonyl, 14-hydroxy-5,10-oxatetradecyl, 5-methoxy-3-oxapentyl, 8-methoxy-3,6-dioxaoctyl, 11-methoxy-3,6,9-trioxaundecyl, 7-methoxy-4-oxaheptyl, 11-methoxy-4,8-dioxa-undecyl, 15-methoxy-4,8,12-trioxapentadecyl, 9-methoxy-5-oxanonyl, 14-methoxy-5,10-oxatetradecyl, 5-ethoxy-3-oxapentyl, 8-ethoxy-3,6-dioxaoctyl, 11-ethoxy-3,6,9-trioxaundecyl, 7-ethoxy-4-oxaheptyl, 11-ethoxy-4,8-dioxaundecyl, 15-ethoxy-4,8,12-trioxapentadecyl, 9-ethoxy-5-oxanonyl or 14-ethoxy-5,10-oxatetradecyl.

If two radicals form a ring, these radicals can together form as fused-on building block, for example, 1,3-propylene, 1,4-butylene, 2-oxa-1,3-propylene, 1-oxa-1,3-propylene, 2-oxa-1,3-propenylene, 1-aza-1,3-propenylene, 1-C₁-C₄-alkyl-1-aza-1,3-propenylene, 1,4-buta-1,3-dienylene, 1-aza-1,4-buta-1,3-dienylene or 2-aza-1,4-buta-1,3-dienylene.

The number of nonadjacent oxygen and/or sulfur atoms and/or imino groups is in principle not subject to any restrictions or is automatically restricted by the size of the radical or the cyclic building block. In general, there will be no more than 5 in the respective radical, preferably no more than 4 and very particularly preferably no more than 3. Furthermore, there is generally at least one carbon atom, preferably at least two carbon atoms, between any two heteroatoms.

Substituted and unsubstituted imino groups can be, for example, imino, methylimino, isopropylimino, n-butylimino or tert-butylimino.

The term “functional groups” refers, for example, to the following: carboxy, carboxamide, hydroxy, di-(C₁-C₄-alkyl)amino, C₁-C₄-alkyloxycarbonyl, cyano or C₁-C₄-alkoxy. Here, C₁-C₄-alkyl is methyl, ethyl, propyl, isopropyl, n-butyl, sec-butyl or tert-butyl.

C₆-C₁₄-aryl which may optionally be substituted by functional groups, aryl, alkyl, aryloxy, alkyloxy, halogen, heteroatoms and/or heterocycles is, for example, phenyl, tolyl, xylyl, α-naphthyl, -naphthyl, 4-diphenylyl, chlorophenyl, dichlorophenyl, trichlorophenyl, difluorophenyl, methylphenyl, dimethylphenyl, trimethylphenyl, ethylphenyl, diethylphenyl, isopropylphenyl, tert-butylphenyl, dodecylphenyl, methoxyphenyl, dimethoxyphenyl, ethoxyphenyl, hexyloxyphenyl, methylnaphthyl, isopropylnaphthyl, chloronaphthyl, ethoxynaphthyl, 2,6-dimethylphenyl, 2,4,6-trimethylphenyl, 2,6-dimethoxyphenyl, 2,6-dichlorophenyl, 4-bromophenyl, 2- or 4-nitrophenyl, 2,4- or 2,6-dinitrophenyl, 4-dimethylaminophenyl, 4-acetylphenyl, methoxyethylphenyl or ethoxymethylphenyl.

C₅-C₁₂-cycloalkyl which may optionally be substituted by functional groups, aryl, alkyl, aryloxy, halogen, heteroatoms and/or heterocycles is, for example, cyclopentyl, cyclohexyl, cyclooctyl, cyclododecyl, methylcyclopentyl, dimethylcyclopentyl, methylcyclohexyl, dimethylcyclohexyl, diethylcyclohexyl, butylcyclohexyl, methoxycyclohexyl, dimethoxycyclohexyl, diethoxycyclohexyl, butylthiocyclohexyl, chlorocyclohexyl, dichlorocyclohexyl, dichlorocyclopentyl or a saturated or unsaturated bicyclic system such as norbornyl or norbornenyl.

A five- or six-membered, oxygen-, nitrogen- and/or sulfur-comprising heterocycle is, for example, furyl, thiophenyl, pyrryl, pyridyl, indolyl, benzoxazolyl, dioxolyl, dioxyl, benzimidazolyl, benzthiazolyl, dimethylpyridyl, methylquinolyl, dimethylpyrryl, methoxyfuryl, dimethoxypyridyl, difluoropyridyl, methylthiophenyl, isopropylthiophenyl or tert-butylthiophenyl.

Preferred anions are selected from the group of halides and halogen-comprising compounds, the group of sulfates, sulfites and sulfonates, the group of phosphates and the group of carboxylic acids, in particular from the group of halides and halogen-comprising compounds, the group of carboxylic acids, the group consisting of SO₄²⁻, SO₃²⁻, R^{a}OSO₃⁻ and R^{a}SO₃⁻ and the group consisting of PO₄³⁻ and R^{a}R^{b}PO₄⁻.

Preferred anions are, in particular, chloride, bromide, iodide, SCN⁻, OCN⁻, CN⁻, acetate, propionate, benzoate, C₁-C₄-alkylsulfates, R^{a}—COO⁻, R^{a}SO₃⁻, R^{a}R^{b}PO₄⁻, methanesulfonate, tosylate or di(C₁-C₄-alkyl)phosphates.

Particularly preferred anions are Cl⁻, CH₃COO⁻, C₂H₅COO⁻, C₆H₅COO⁻, CH₃SO₃⁻, (CH₃O)₂PO₂⁻ and (C₂H₅O)₂PO₂⁻.

In a further preferred embodiment, ionic liquids of the formula I in which
[A]ₙ⁺ is 1-methylimidazolium, 1-ethylimidazolium, 1-(1-butyl)imidazolium, 1-(1-octyl)imidazolium, 1-(1-dodecyl)imidazolium, 1-(1-tetradecyl)imidazolium, 1-(1-hexadecyl)imidazolium, 1,3-dimethylimidazolium, 1-ethyl-3-methylimidazolium, 1-(1-butyl)-3-methylimidazolium, 1-(1-butyl)-3-ethylimidazolium, 1-(1-hexyl)-3-methylimidazolium, 1-(1-hexyl)-3-ethylimidazolium, 1-(1-hexyl)-3-butylimidazolium, 1-(1-octyl)-3-methylimidazolium, 1-(1-octyl)-3-ethylimidazolium, 1-(1-octyl)-3-butylimidazolium, 1-(1-dodecyl)-3-methylimidazolium, 1-(1-dodecyl)-3-ethylimidazolium, 1-(1-dodecyl)-3-butylimidazolium, 1-(1-dodecyl)-3-octylimidazolium, 1-(1-tetradecyl)-3-methylimidazolium, 1-(1-tetradecyl)-3-ethylimidazolium, 1-(1-tetradecyl)-3-butylimidazolium, 1-(1-tetradecyl)-3-octylimidazolium, 1-(1-hexadecyl)-3-methylimidazolium, 1-(1-hexadecyl)-3-ethylimidazolium, 1-(1-hexadecyl)-3-butylimidazolium, 1-(1-hexadecyl)-3-octylimidazolium, 1,2-dimethylimidazolium, 1,2,3-trimethylimidazolium, 1-ethyl-2,3-dimethylimidazolium, 1-(1-butyl)-2,3-dimethylimidazolium, 1-(1-hexyl)-2,3-dimethylimidazolium, 1-(1-octyl)-2,3-dimethylimidazolium, 1,4-dimethylimidazolium, 1,3,4-trimethylimidazolium, 1,4-dimethyl-3-ethylimidazolium, 1,4-dimethyl-3-butylimidazolium, 1,4-dimethyl-3-octylimidazolium, 1,4,5-trimethylimidazolium, 1,3,4,5-tetramethylimidazolium, 1,4,5-trimethyl-3-ethylimidazolium, 1,4,5-trimethyl-3-butylimidazolium, 1,4,5-trimethyl-3-octylimidazolium and 1-(prop-1-en-3-yl)-3-methylimidazolium; and
[Y]ⁿ⁺ is Cl⁻, CH₃COO⁻, C₂H₅COO⁻, C₆H₅COO⁻, CH₃SO₃⁻, (CH₃O)₂PO₂⁻ or (C₂H₅O)₂PO₂⁻;

are used.

In a further preferred embodiment, ionic liquids whose anions are selected from the group consisting of HSO₄⁻, HPO₄²⁻, H₂PO₄⁻ and HR^{a}PO₄⁻, in particular HSO₄⁻, are used.

In particular, ionic liquids of the formula I in which
[A]ₙ⁺ is 1-methylimidazolium, 1-ethylimidazolium, 1-(1-butyl)imidazolium, 1-(1-octyl)imidazolium, 1-(1-dodecyl)imidazolium, 1-(1-tetradecyl)imidazolium, 1-(1-hexadecyl)imidazolium, 1,3-dimethylimidazolium, 1-ethyl-3-methylimidazolium, 1-(1-butyl)-3-methylimidazolium, 1-(1-butyl)-3-ethylimidazolium, 1-(1-hexyl)-3-methylimidazolium, 1-(1-hexyl)-3-ethylimidazolium, 1-(1-hexyl)-3-butylimidazolium, 1-(1-octyl)-3-methylimidazolium, 1-(1-octyl)-3-ethylimidazolium, 1-(1-octyl)-3-butylimidazolium, 1-(1-dodecyl)-3-methylimidazolium, 1-(1-dodecyl)-3-ethylimidazolium, 1-(1-dodecyl)-3-butylimidazolium, 1-(1-dodecyl)-3-octylimidazolium, 1-(1-tetradecyl)-3-methylimidazolium, 1-(1-tetradecyl)-3-ethylimidazolium, 1-(1-tetradecyl)-3-butylimidazolium, 1-(1-tetradecyl)-3-octylimidazolium, 1-(1-hexadecyl)-3-methylimidazolium, 1-(1-hexadecyl)-3-ethylimidazolium, 1-(1-hexadecyl)-3-butylimidazolium, 1-(1-hexadecyl)-3-octylimidazolium, 1,2-dimethylimidazolium, 1,2,3-trimethylimidazolium, 1-ethyl-2,3-dimethylimidazolium, 1-(1-butyl)-2,3-dimethylimidazolium, 1-(1-hexyl)-2,3-dimethylimidazolium, 1-(1-octyl)-2,3-dimethylimidazolium, 1,4-dimethylimidazolium, 1,3,4-trimethylimidazolium, 1,4-dimethyl-3-ethylimidazolium, 1,4-dimethyl-3-butylimidazolium, 1,4-dimethyl-3-octylimidazolium, 1,4,5-trimethylimidazolium, 1,3,4,5-tetramethylimidazolium, 1,4,5-trimethyl-3-ethylimidazolium, 1,4,5-trimethyl-3-butylimidazolium, 1,4,5-trimethyl-3-octylimidazolium or 1-(prop-1-en-3-yl)-3-methylimidazolium; and
[Y]ⁿ⁺ is HSO₄⁻;

are used.

In the process of the invention, use is made of one ionic liquid of the formula I or a mixture of ionic liquids of the formula I. Preference is given to using one ionic liquid of the formula I.

In a further embodiment of the invention, it is possible to use one ionic liquid of the formula II or a mixture of ionic liquids of the formula II. Preference is given to using one ionic liquid of the formula II.

In a further embodiment of the invention, it is possible to use a mixture of ionic liquids of the formulae I and II.

Ketenes which can be used for the purposes of the present invention are ketenes of the formula IVa and diketenes which can be used for the purposes of the present invention are diketenes of the formula IVb1 or mixed diketenes of the formula IVb2,

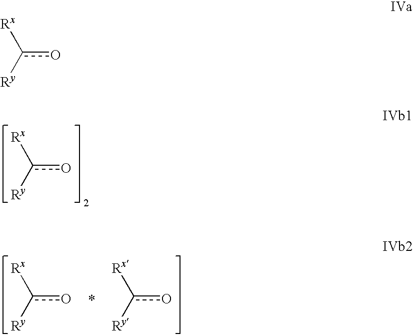

where the radicals have the following meanings:
R^{x}, R^{x′}, R^{y}, R^{y′} are each hydrogen, C₁-C₃₀-alkyl, C₂-C₃₀-alkenyl, C₂-C₃₀-alkynyl C₃-C₁₂-cycloalkyl, C₅-C₁₂-cycloalkenyl, aryl or heterocyclyl, where the latter seven radicals may optionally be substituted;
   or
   R^{x} and R^{y} or R^{x′} and R^{y′} together form an optionally substituted —Xₒ—(CH₂)ₚ—, —(CH₂)_{q}—X—(CH₂)ᵣ— or —CH═CH—CH═CH— chain, where
   X is O, S, S(═O), S(═O)₂ or NR^{z};
   R^{z} is hydrogen or C₁-C₆-alkyl;
   o is 0 or 1;
   p is 2, 3, 4, 5, 6, 7 or 8;
   q, r are each 1, 2, 3, 4, 5 or 6.

Optionally substituted C₁-C₃₀-alkyl radicals R^{x}, R^{x′}, R^{y} and R^{y′} are, in particular, unsubstituted C₁-C₃₀-alkyl radicals or C₁-C₃₀-alkyl radicals substituted by functional groups, aryl, alkyl, aryloxy, alkyloxy, cycloalkyl, halogen, heteroatoms and/or heterocycles,

preferably C₁-C₃₀-alkyl radicals, for example methyl, ethyl, 1-propyl, 2-propyl, 1-butyl, 2-butyl, 2-methyl-1-propyl, 2-methyl-2-propyl, 1-pentyl, 2-pentyl, 3-pentyl, 2-methyl-1-butyl, 3-methyl-1-butyl, 2-methyl-2-butyl, 3-methyl-2-butyl, 2,2-dimethyl-1-propyl, 1-hexyl, 2-hexyl, 3-hexyl, 2-methyl-1-pentyl, 3-methyl-1-pentyl, 4-methyl-1-pentyl, 2-methyl-2-pentyl, 3-methyl-2-pentyl, 4-methyl-2-pentyl, 2-methyl-3-pentyl, 3-methyl-3-pentyl, 2,2-dimethyl-1-butyl, 2,3-dimethyl-1-butyl, 3,3-dimethyl-1-butyl, 2-ethyl-1-butyl, 2,3-dimethyl-2-butyl, 3,3-dimethyl-2-butyl, heptyl, octyl, 2-ethylhexyl, 2,4,4-trimethylpentyl, 1,1,3,3-tetramethylbutyl, 1-nonyl, 1-decyl, 1-undecyl, 1-dodecyl, 1-tridecyl, 1-tetradecyl, 1-pentadecyl, 1-hexadecyl, 1-heptadecyl, 1-octadecyl and 1-eicosanyl, particularly preferably methyl, ethyl, 1-propyl, 1-butyl, 1-decyl, 1-dodecyl, 1-tetradecyl or 1-hexadecyl;

or

preferably C₁-C₃₀-alkyl radicals substituted by functional groups, aryl, alkyl, aryloxy, alkyloxy, cycloalkyl, halogen, heteroatoms and/or heterocycles, for example cyanomethyl, 2-cyanoethyl, 2-cyanopropyl, methoxycarbonylmethyl, 2-methoxycarbonylethyl, ethoxycarbonylmethyl, 2-ethoxycarbonylethyl, 2-(butoxycarbonyl)ethyl, 2-butoxycarbonylpropyl, 1,2-di(methoxycarbonyl)ethyl, formyl, hydroxymethyl, 2-hydroxyethyl, 2-hydroxypropyl, 3-hydroxypropyl, 4-hydroxybutyl, 6-hydroxyhexyl, 2-hydroxy-2,2-dimethylethyl, aminomethyl, 2-aminoethyl, 2-aminopropyl, 3-aminopropyl, 4-aminobutyl, 6-aminohexyl, methylaminomethyl, 2-methylaminoethyl, 2-methylaminopropyl, 3-methylaminopropyl, 4-methylaminobutyl, 6-methylaminohexyl, dimethylaminomethyl, 2-dimethylaminoethyl, 2-dimethylaminopropyl, 3-dimethylaminopropyl, 4-dimethylaminobutyl, 6-dimethylaminohexyl, phenoxymethyl, 2-phenoxyethyl, 2-phenoxypropyl, 3-phenoxypropyl, 4-phenoxybutyl, 6-phenoxyhexyl, methoxymethyl, 2-methoxyethyl, 2-methoxypropyl, 3-methoxypropyl, 4-methoxybutyl, 6-methoxyhexyl, ethoxymethyl, 2-ethoxyethyl, 2-ethoxypropyl, 3-ethoxypropyl, 4-ethoxybutyl, 6-ethoxyhexyl, 2-butoxyethyl, 2-isopropoxyethyl, 2-butoxypropyl, 2-octyloxyethyl, 2-methoxyisopropyl, dimethoxymethyl, diethoxymethyl, 2,2-diethoxymethyl, 2,2-diethoxyethyl, acetyl, propionyl, CₘF_{2(m-a)+(1-b)}H_{2a+b} where m is from 1 to 30, 0≦a≦m and b=0 or 1 (for example CF₃, C₂F₅, CH₂CH₂—C₍ₘ₋₂₎F₂₍ₘ₋₂₎₊₁, C₆F₁₃, C₈F₁₇, C₁₀F₂₁, C₁₂F₂₅), chloromethyl, 2-chloroethyl, trichloromethyl, 1,1-dimethyl-2-chloroethyl, methylthiomethyl, ethylthiomethyl, butylthiomethyl, 2-dodecylthioethyl, 2-phenylthioethyl, 5-hydroxy-3-oxapentyl, 8-hydroxy-3,6-dioxaoctyl, 11-hydroxy-3,6,9-trioxaundecyl, 7-hydroxy-4-oxaheptyl, 11-hydroxy-4,8-dioxaundecyl, 15-hydroxy-4,8,12-trioxapentadecyl, 9-hydroxy-5-oxanonyl, 14-hydroxy-5,10-dioxatetradecyl, 5-methoxy-3-oxapentyl, 8-methoxy-3,6-dioxaoctyl, 11-methoxy-3,6,9-trioxaundecyl, 7-methoxy-4-oxaheptyl, 11-methoxy-4,8-dioxaundecyl, 15-methoxy-4,8,12-trioxapentadecyl, 9-methoxy-5-oxanonyl, 14-methoxy-5,10-dioxatetradecyl, 5-ethoxy-3-oxapentyl, 8-ethoxy-3,6-dioxaoctyl, 11-ethoxy-3,6,9-trioxaundecyl, 7-ethoxy-4-oxaheptyl, 11-ethoxy-4,8-dioxaundecyl, 15-ethoxy-4,8,12-trioxapentadecyl, 9-ethoxy-5-oxanonyl or 14-ethoxy-5,10-oxatetradecyl.

Optionally substituted C₂-C₃₀-alkenyl radicals R^{x}, R^{x′}, R^{y} and R^{y′} are, in particular, unsubstituted C₂-C₃₀-alkenyl radicals or C₂-C₃₀-alkenyl radicals substituted by functional groups, aryl, alkyl, aryloxy, alkyloxy, cycloalkyl, halogen, heteroatoms and/or heterocycles,

preferably C₂-C₃₀-alkenyl radicals, for example vinyl, 2-propenyl, 3-butenyl, cis-2-butenyl or trans-2-butenyl, particularly preferably vinyl or 2-propenyl;

or

preferably C₂-C₃₀-alkenyl radicals substituted by functional groups, aryl, alkyl, aryloxy, alkyloxy, cycloalkyl, halogen, heteroatoms and/or heterocycles, for example CₘF_{2(m-a)-(1-b)}H_{2a-b} where m≦30, 0≦a≦m and b=0 or 1.

Optionally substituted C₂-C₃₀-alkynyl radicals R^{x}, R^{x′}, R^{y} and R^{y′} are, in particular, unsubstituted C₂-C₃₀-alkynyl radicals or C₂-C₃₀-alkynyl radicals substituted by functional groups, aryl, alkyl, aryloxy, alkyloxy, cycloalkyl, halogen, heteroatoms and/or heterocycles;

preferably C₂-C₃₀-alkynyl radicals such as ethynyl, 1-propyn-3-yl, 1-propyn-1-yl or 3-methyl-1-propyn-3-yl, particularly preferably ethynyl or 1-propyn-3-yl.

Optionally substituted C₃-C₁₂-cycloalkyl radicals R^{x}, R^{x′}, R^{y} and R^{y′} are, in particular, unsubstituted C₃-C₈-cycloalkyl radicals or C₃-C₁₂-cycloalkyl radicals substituted by functional groups, aryl, alkyl, aryloxy, alkyloxy, cycloalkyl, halogen, heteroatoms and/or heterocycles,

preferably C₃-C₁₂-cycloalkyl radicals, for example cyclopropyl, cyclobutyl, cyclopentyl, cyclohexyl, cyclooctyl, cyclododecyl, methylcyclopentyl, dimethylcyclopentyl, methylcyclohexyl, dimethylcyclohexyl, diethylcyclohexyl or butylcyclohexyl, and also bicyclic systems such as norbornyl, preferably cyclopentyl or cyclohexyl;

or

preferably C₃-C₁₂-cycloalkyl radicals substituted by functional groups, aryl, alkyl, aryloxy, alkyloxy, cycloalkyl, halogen, heteroatoms and/or heterocycles, for example methoxycyclohexyl, dimethoxycyclohexyl, diethoxycyclohexyl, butylthiocyclohexyl, chlorocyclohexyl, dichlorocyclohexyl, dichlorocyclopentyl, CₘF_{2(m-a)-(1-b)}H_{2a-b} where m≦30, 0≦a≦m and b=0 or 1.

Optionally substituted C₅-C₁₂-cycloalkenyl radicals R^{x}, R^{x′}, R^{y} and R^{y′} are, in particular, unsubstituted C₃-C₈-cycloalkenyl radicals or C₃-C₈-cycloalkenyl radicals substituted by functional groups, aryl, alkyl, aryloxy, alkyloxy, cycloalkyl, halogen, heteroatoms and/or heterocycles,

preferably C₃-C₈-cycloalkenyl radicals, for example 3-cyclopentenyl, 2-cyclohexenyl, 3-cyclohexenyl, 2,5-cyclohexadienyl, and also bicyclic systems such as norbornyl, particularly preferably 3-cyclopentenyl, 2-cyclohexenyl or 3-cyclohexenyl;

or

preferably C₃-C₈-cycloalkenyl radicals substituted by functional groups, aryl, alkyl, aryloxy, alkyloxy, cycloalkyl, halogen, heteroatoms and/or heterocycles, for example CₙF_{2(m-a)-3(1-b)}H_{2a-3b} where m≦12, 0≦a≦m and b=0 or 1.

Optionally substituted aryl radicals R^{x}, R^{x′}, R^{y} and R^{y′} are, in particular, unsubstituted C₆-C₁₂-aryl radicals or C₆-C₁₂-aryl radicals substituted by functional groups, aryl, alkyl, aryloxy, alkyloxy, cycloalkyl, halogen, heteroatoms and/or heterocycles, preferably C₆-C₁₂-aryl radicals, for example phenyl, α-naphthyl or β-naphthyl, particularly preferably phenyl;

or

preferably C₆-C₁₂-aryl radicals substituted by functional groups, aryl, alkyl, aryloxy, alkyloxy, cycloalkyl, halogen, heteroatoms and/or heterocycles, e.g. tolyl, xylyl, 4-diphenylyl, chlorophenyl, dichlorophenyl, trichlorophenyl, difluorophenyl, methylphenyl, dimethylphenyl, trimethylphenyl, ethylphenyl, diethylphenyl, isopropylphenyl, tert-butylphenyl, dodecylphenyl, methoxyphenyl, dimethoxyphenyl, ethoxyphenyl, hexyloxyphenyl, methylnaphthyl, isopropylnaphthyl, chloronaphthyl, ethoxynaphthyl, 2,6-dimethylphenyl, 2,4,6-trimethylphenyl, 2,6-dimethoxyphenyl, 2,6-dichlorophenyl, 4-bromophenyl, 2-nitrophenyl, 4-nitrophenyl, 2,4-dinitrophenyl, 2,6-dinitrophenyl, 4-dimethylaminophenyl, 4-acetylphenyl, methoxyethylphenyl, ethoxymethylphenyl, methylthiophenyl, isopropylthiophenyl or tert-butylthiophenyl or C₆F₍₅₋ₐ₎Hₐ where 0≦a≦5, particularly preferably 4-tolyl.

Optionally substituted heterocyclyl radicals are, in particular, unsubstituted heteroaryl radicals or heteroaryl radicals substituted by functional groups, aryl, alkyl, aryloxy, alkyloxy, cycloalkyl, halogen, heteroatoms and/or heterocycles,

preferably 5- or 6-membered heteroaryl radicals comprising oxygen, nitrogen and/or sulfur atoms, e.g. furyl, thiophenyl, pyrryl, pyridyl, indolyl, benzoxazolyl, dioxolyl, dioxyl, benzimidazolyl or benzothiazolyl;

or

preferably 5- or 6-membered heteroaryl radicals which are substituted by functional groups, aryl, alkyl, aryloxy, alkyloxy, cycloalkyl, halogen, heteroatoms and/or heterocycles and comprise oxygen, nitrogen and/or sulfur atoms, e.g. methylpyridyl, dimethylpyridyl, methylquinolyl, dimethylpyrryl, methoxyfuryl, dimethoxypyridyl, chloropyridyl or difluoropyridyl.

If R^{x} and R^{y} or R^{x′} and R^{y′} together form an optionally substituted —Xₒ—(CH₂)ₚ—, —(CH₂)_{q}—X—(CH₂)ᵣ— or —CH═CH—CH═CH— chain, preference is given to a —Xₒ—(CH₂)ₚ—, —(CH₂)_{q}—X—(CH₂)ᵣ— or —CH═CH—CH═CH— chain, particularly preferably —(CH₂)₅—, —(CH₂)₆— or —CH═CH—CH═CH—, in particular —(CH₂)₅— or —(CH₂)₆—,

or

a C₁-C₄-alkyl-substituted —Xₒ—(CH₂)ₚ— or —(CH₂)_{q}—X—(CH₂)ᵣ— chain or a C₁-C₄-alkyl-substituted —CH═CH—CH═CH— chain.

In an embodiment of the present invention, ketenes of the formula IVa are used.

Particular preference is given to using ketenes of the formula IVa in which the radicals have the following meanings:
R^{x} is hydrogen or C₁-C₁₈-alkyl, preferably hydrogen or C₁-C₆-alkyl; particularly preferably hydrogen, methyl or ethyl; extraordinarily preferably hydrogen;
R^{y} is hydrogen.

Particular preference is likewise given to using ketenes of the formula IVa in which the radicals have the following meanings:
R^{x} is 1-decyl, 1-dodecyl, 1-tetradecyl or 1-hexadecyl;
R^{y} is hydrogen.

In a further embodiment of the present invention, diketenes of the formula IVb1 are used.

Particular preference is given to using diketenes of the formula IVb1 in which the radicals have the following meanings:
R^{x} is hydrogen or C₁-C₁₈-alkyl, preferably hydrogen or C₁-C₆-alkyl, particularly preferably hydrogen, methyl or ethyl, in particular hydrogen;
R^{y} is hydrogen.

Particular preference is likewise given to ketenes of the formula IVb1 in which the radicals have the following meanings:
R^{x} is 1-decyl, 1-dodecyl, 1-tetradecyl or 1-hexadecyl;
R^{y} is hydrogen.

In a further embodiment of the present invention, mixed diketenes of the formula IVb2 are used.

Particular preference is given to using mixed diketenes of the formula IVb2 in which the radicals have the following meanings:
R^{x}, R^{x′} are each hydrogen or C₁-C₆-alkyl, preferably hydrogen, methyl or ethyl, in particular hydrogen;
R^{y}, R^{y′} are each hydrogen.

Particular preference is likewise given to using ketenes of the formula IVb2 in which the radicals have the following meanings:
R^{x}, R^{x′} are each 1-decyl, 1-dodecyl, 1-tetradecyl or 1-hexadecyl
R^{y}, R^{y′} are each hydrogen.

In the acylation according to the invention of cellulose, it is possible to use celluloses from a wide variety of sources, e.g. from cotton, flax, ramie, straw, bacteria, etc. or from wood or bagasse, in the cellulose-enriched form.

However, the process of the invention can be used not only for the acylation of cellulose but also generally for the acylation of polysaccharides, oligosaccharides and disaccharides and also derivatives thereof. Examples of polysaccharides include cellulose and hemicellulose and also starch, glycogen, dextran and tunicin. Further examples are the polycondensates of D-fructose, e.g. inulin, and also, inter alia, chitin alginic acid. Sucrose is an example of a disaccharide. Suitable cellulose derivatives are those whose DS is <3, including cellulose ethers such as methyl cellulose and carboxymethylcellulose, cellulose esters such as cellulose acetate, cellulose butyrate and cellulose nitrate, in each case with a DS of <3. The corresponding statements apply analogously here.

In one embodiment of the present invention, a polysaccharide such as cellulose, hemicellulose, starch, glycogen, dextran, tunicin, inulin, chitin or alginic acid, preferably cellulose, is acylated by the process of the invention.

In a further embodiment of the present invention, a disaccharide such as sucrose is acylated by the process of the invention.

In a further embodiment of the present invention, a cellulose derivative whose DS is <3, e.g. a cellulose ether such as methylcellulose or-carboxymethylcellulose, a cellulose ester such as cellulose acetate, cellulose butyrate or cellulose nitrate, in each case having a DS of <3, is acylated by the process of the invention. In the process of the invention, a solution of cellulose in an ionic liquid is prepared. The concentration of cellulose here can be varied within a wide range. It is usually in the range from 0.1 to 50% by weight, based on the total weight of the solution, preferably from 0.2 to 40% by weight, particularly preferably from 0.3 to 30% by weight and very particularly preferably from 0.5 to 20% by weight.

This dissolution procedure can be carried out at room temperature or with heating, but above the melting point or softening temperature of the ionic liquid, usually at a temperature of from 0 to 200° C., preferably from 20 to 180° C., particularly preferably from 50 to 150° C. However, it is also possible to accelerate dissolution by intensive stirring or mixing or by introduction of microwave or ultrasonic energy or by a combination of these.

The ketene of the formula IV is then added to the resulting solution.

The ketene of the formula IV can be added as such or as a solution in an ionic liquid or a suitable solvent. Suitable solvents are, for example, ethers such as diethyl ether, methyl tert-butyl ether, tetrahydrofuran or dioxane, or ketones such as dimethyl ketone, or halogenated hydrocarbons such as dichloromethane, trichloromethane or dichloroethane. The amount of solvent used to dissolve the ketene of the formula IV should be such that no precipitation of the cellulose occurs when the addition is carried out. Ionic liquids used are preferably those in which cellulose itself, as described above, is dissolved.

If the ketene of the formula IV is gaseous, this can be passed in gaseous form into the solution of cellulose in the ionic liquid.

In a particular embodiment, the ketene of the formula IV is added as such.

In a further particular embodiment, the ketene of the formula IV is added as a solution in an ionic liquid, with particular preference being given to using the ionic liquid which is also used for dissolving the cellulose.

In another embodiment, the ionic liquid and the ketene of the formula IV are premixed and the cellulose is dissolved in this mixture.

It is also possible for one or more further solvents to be added to the reaction mixture or be introduced together with the ionic liquid or the ketene of the formula IV. Possible solvents here are solvents which do not adversely affect the solubility of the cellulose, for example aprotic dipolar solvents such as dimethyl sulfoxide, dimethylformamide, dimethylacetamide or sulfolane. Furthermore, nitrogen-comprising bases such as pyridine, etc., can be additionally added.

In a particular embodiment, the reaction mixture comprises, apart from the ionic liquid and any solvent in which the ketene of the formula IV has been dissolved, less than 5% by weight, preferably less than 2% by weight, in particular less than 0.1% by weight, based on the total weight of the reaction mixture, of further solvents and/or additional nitrogen-comprising bases.

It is also possible to carry out the process of the invention in the presence of a catalyst. Suitable catalysts here are the alkali metal or alkaline earth metal salts of C₁-C₄-alkanecarboxylic acids or of benzoic acid. Examples are sodium acetate, potassium acetate, sodium propionate, potassium propionate, sodium benzoate or potassium benzoate, preferably sodium acetate. However, it is also possible to use the acids themselves, i.e. the C₁-C₄-alkanecarboxylic acids or benzoic acid. The catalyst is usually used in amounts of up to 10 mol %, preferably up to 8 mol %, based on the ketene of the formula IV.

The reaction is, depending on the ionic liquid used and the ketene of the formula IV used, usually carried out at a temperature from the melting point of the ionic liquid up to 200° C., preferably from 20 to 180° C., in particular from 50 to 150° C.

In the case of ketenes of the formula IV which are liquid or solid at the reaction temperature, the reaction is usually carried out at ambient pressure. However, in some cases it can also be advantageous to carry it out under superatmospheric pressure, particularly when a volatile ketene of the formula IV is used. The reaction is generally carried out in air. However, it is also possible to carry it out under an inert gas, i.e., for example, under N₂, a noble gas, CO₂ or mixtures thereof.

In the case of ketenes of the formula IV which are gaseous at the reaction temperature, it can be advantageous to carry out the reaction under the autogenous pressure of the reaction mixture at the desired reaction temperature or at a pressure which is higher than the autogenous pressure of the reaction system.

However, it can also be advantageous to carry out the reaction with a ketene of the formula IV which is gaseous at the reaction temperature under ambient pressure and to use the gaseous ketene of the formula IV in excess.

The amount of acylating agent used, in each case relative to the amount of cellulose used, the reaction time and, if appropriate, the reaction temperature are set as a function of the desired degree of substitution of the cellulose.

For example, if the cellulose which is made up of an average of u anhydroglucose units is to be completely acylated, then 3u equivalents of ketene of the formula IV are required. Preference is here given to using the stoichiometric amount of ketene of the formula IV (nₖₑₜₑₙₑ/n_{anhydroglucose units}=3) or an excess, preferably an excess of up to 1000 mol % based on u.

If the cellulose which is made up of an average of u anhydroglucose units is to be partially acylated, then the amounts of ketene of the formula IV used are usually adapted (nₖₑₜₑₙₑ/n_{anhydroglucose units}<3). The smaller the ratio nₖₑₜₑₙₑ/n_{anhydroglucose units}, the smaller the average degree of substitution of the acylated cellulose under otherwise identical conditions and identical reaction times.

Furthermore, it is possible to stop the acylation reaction when the desired degree of acylation has been reached by separating off the acylated cellulose from the reaction mixture. This can be effected, for example, by addition of an excess of water or another suitable solvent in which the acylated cellulose is not soluble but the ionic liquid is readily soluble, e.g. a lower alcohol such as methanol, ethanol, propanol or butanol, or a ketone, for example diethyl ketone, etc., or mixtures thereof. The choice of suitable solvent is also determined by the respective degree of substitution and the substituents on the cellulose. Preference is given to using an excess of water or methanol.

The reaction mixture is usually worked up by precipitating the acylated cellulose as described above and filtering off the acylated cellulose. The ionic liquid can be recovered from the filtrate by conventional methods, by distilling off the volatile components, e.g. the precipitant or excess ketene of the formula IV, etc. The ionic liquid which remains can be reused in the process of the invention. In a further embodiment, excess ketene can also remain in the ionic liquid and be reused in the process of the invention.

However, it is also possible to introduce the reaction mixture into water or into another suitable solvent in which the acylated cellulose is not soluble but the ionic liquid is readily soluble, e.g. a lower alcohol such as methanol, ethanol, propanol or butanol, or a ketone, for example diethyl ketone, etc., or mixtures thereof and, depending on the embodiment, to obtain, for example, fibers, films of acylated cellulose. The choice of suitable solvent is also determined by the respective degree of substitution and the substituents on the cellulose. The filtrate is worked up as described above.

Furthermore, it is possible to stop the acylation reaction when the desired degree of acylation has been reached by cooling the reaction mixture and working it up. The work-up can be carried out by the methods indicated above.

The acylation reaction can also be stopped by removing ketene of the formula IVa or diketene of the formula IVb still present from the reaction mixture by distillation, stripping or extraction with a solvent which forms two phases with the ionic liquid at a given point in time.

In a further embodiment of the present invention, two or more ketenes of the formula IV are reacted. It is possible here to use a mixture of two (or more) ketenes of the formula IV in a manner analogous to the above procedure. However, it is also possible firstly to carry out the reaction to a DS=a(<3) using the first ketene of the formula IV and then to carry out the reaction to a DS=b, where a<b≦3, using a second ketene.

In this embodiment, acylated celluloses which have two (or more) different acyl radicals (as a function of the ketenes of the formula IV used) are obtained.

If the ionic liquid is circulated, the ionic liquid can comprise up to 15% by weight, preferably up to 10% by weight, in particular up to 5% by weight, of precipitate(s) as described above.

The process can be carried out bathwise, semicontinuously or continuously.

The present invention also provides acylated celluloses which are obtainable by reaction of cellulose with a diketene of the formula IVb1 or the formula IVb2 in an ionic liquid of the formula I or II.

If the acylation is carried out using a diketene of the formula IVb1, up to all, depending on the degree of conversion, hydroxy groups (—O—H) of the cellulose are replaced by the group —O—CO—CR^{x}R^{y}—CO—CHR^{x}R^{y}.

If the acylation is carried out using a diketene of the formula IVb2, up to all, depending on the degree of conversion, hydroxy groups (—O—H) of the cellulose are replaced by the groups —O—CO—CR^{x}R^{y}—CO—CHR^{x′}R^{y′} and —O—CO—CR^{x′}R^{y′}—CO—CHR^{x′}R^{y′}.

The acylated celluloses which can be obtained by acylation of cellulose by means of a diketene of the formula IVb1 or IVb according to the process of the invention are suitable for producing films and fibers or materials.

The following examples serve to illustrate the invention.

Preliminary Remark:

Avicel PH 101 (microcrystalline cellulose) was dried overnight at 105° C. and 0.05 mbar.

The ionic liquids were dried overnight at 120° C. and 0.05 mbar while stirring. All examples were carried out in an atmosphere of dry argon.

The average degree of substitution DS of the acylated cellulose was determined by means of NMR spectroscopic methods.

### ABBREVIATIONS

BMIM Cl 1-butyl-3-methylimidazolium chloride

EMIM Ac 1-ethyl-3-methylimidazolium acetate

AGU anhydroglucose unit

DS average degree of substitution

### EXAMPLE 1

### Reaction of Cellulose with Ketene (CH₂═C═O)

23.4 g of Avicel PH 101 were dissolved in 440 g of EMIM Ac by stirring at 100° C. for 3 hours. The clear solution obtained in this way was, after cooling to room temperature, transferred to a 1 liter reaction vessel provided with thermostatted jacket, gas inlet tube and disc stirrer and heated to 90° C. While stirring, a stream of 6.6 g/h of ketene (diluted with nitrogen: 30% of ketene, 70% of nitrogen) was passed into the solution at an internal temperature of 80-90° C. The offgas comprised only small traces of ketene. After the reaction times indicated in Table 1, an about 20 g sample was taken in each case and cooled to room temperature. The samples were in each case introduced into ten times the amount of methanol, resulting in formation of a precipitate. This was filtered off with suction, washed with methanol and dried.

TABLE 1

| Sample No. | Reaction time | n_{(AGUs)}:n₍ₖₑₜₑₙₑ₎ | DS of the product |
|---|---|---|---|
| 1a | 1 h | 1 mol:1.1 mol | 1.2 |
| 1b | 2 h | 1 mol:2.2 mol | 2.1 |
| 1c | 3 h | 1 mol:3.3 mol | 3.0 |

### EXAMPLE 2

### Reaction of Cellulose with Diketene (H₂C═C═O)₂

11 ml of BMIM Cl were heated to 110° C. and 1.151 g of Avicel PH 101 were added while stirring. Stirring at 110° C. for 2 hours gave a clear solution to which 0.717 g of diketene (H₂C═C═O)₂ was added dropwise over a period of 30 minutes. After stirring at 110° C. for a further 40 minutes, the reaction mixture was added to 200 ml of methanol, the precipitate formed was filtered off with suction, washed three times with 20 ml each time of methanol and dried at 60° C. and 0.05 mbar for 16 hours. This gave 1.320 g (87% of theory) of a beige solid having an average degree of substitution of 0.6.

### EXAMPLE 3

### Reaction of Cellulose with Diketene (H₂C═C═O)₂

11 ml of BMIM Cl were heated to 110° C. and 1.024 g of Avicel PH 101 were added while stirring. Stirring at 110° C. for 2 hours gave a clear solution to which 2.346 g of diketene (H₂C═C═O)₂ were added dropwise over a period of 30 minutes. After stirring at 110° C. for a further 40 minutes, the reaction mixture was added to 200 ml of methanol, the precipitate formed was filtered off with suction, washed three times with 20 ml each time of methanol and dried at 60° C. and 0.05 mbar for 16 hours. This gave 1.784 g (79% of theory) of a beige solid having an average degree of substitution of 2.3.

### EXAMPLE 4

### Reaction of Cellulose with an Excess of Various Diketenes (R^{x}HC═C═O)₂; Influence of the Reaction Time

11 ml of BMIM Cl were heated to 110° C. and 1.151 g of Avicel PH 101 were added while stirring. Stirring at 110° C. for 2 hours gave a clear solution to which the amount of diketene indicated in Table 2 was added at 100° C. over a period of 30 minutes. The mixture was stirred at 100° C. for the time indicated in each case, and the reaction mixture was then added to 200 ml of methanol, the precipitate formed was filtered off with suction, washed three times with 20 ml each time of methanol and dried at 60° C. and 0.05 mbar for 16 hours.

### Table 2: Conditions and Results for Example 4

| Experi- | | Reaction | | DS of the |
|---|---|---|---|---|
| ment | Diketene | time | n_{(AGUs)}:n_{(AKD)} | product |
| 4.1a | (CH₂═C═O)₂ | 1 h | 1:4.4 | 1.4 |
| 4.1b | (CH₂═C═O)₂ | 16 h | 1:3.9 | 2.5 |
| 4.2a | (CH₃—CH═C═O)₂ | 3 h | 1:4.9 | 1.1 |
| 4.2b | (CH₃—CH═C═O)₂ | 16 h | 1:3.7 | 2.4 |
| 4.3a | (C₃H₇—CH═C═O)₂ | 1 h | 1:3.7 | 0.2 |
| 4.3b | (C₃H₇—CH═C═O)₂ | 16 h | 1:3.4 | 2.2 |

### EXAMPLE 5

### Reaction of Cellulose with C₁₄/C₁₆-Alkyl Ketene Dimer (Mixed Diketene of the Formula IVb2 in Which R^{x}═C₁₄H₂₉, R^{x′}═C₁₆H₃₃, R^{y} and R^{y′}═H)

11 ml of BMIM Cl were heated to 100° C. and 1.026 g of Avicel PH 101 were added while stirring. Stirring at 100° C. for 2 hours gave a clear solution to which 0.04 g of sodium acetate and 5.0 g of C₁₄/C₁₆-alkyl ketene dimer were added. After stirring at 100° C. for 16 hours, the reaction mixture was added to 200 ml of methanol, the precipitate formed was filtered off with suction, washed three times with 20 ml each time of methanol and subsequently three times with 20 ml of chloroform. The precipitate obtained in this way was dried at 60° C. and 0.05 mbar for 16 hours.

This gave 1.084 g (81% of theory) of a beige solid which has an average degree of substitution of 0.1, is insoluble in chloroform and is soluble in DMSO.

1. A process for acylating polysaccharides, oligosaccharides or disaccharides or derivatives thereof, which comprises dissolving a polysaccharide, oligosaccharide or disaccharide or the appropriate derivative in at least one ionic liquid and reacting it with a ketene.

2. The process according to claim 1, wherein a polysaccharide or a derivative thereof is used as the polysaccharide, oligosaccharide or disaccharide or derivative thereof.

3. The process according to claim 2, wherein cellulose or a cellulose derivative is used as the polysaccharide or derivative thereof.

4. The process according to claim 3, wherein cellulose is used as the polysaccharide or derivative thereof.

5. The process according to claim 1, wherein the ionic liquid or mixture thereof is selected from among the compounds of the formula I,
[A]ₙ⁺[Y]ⁿ⁻ (I),
where
n is 1, 2, 3 or 4;
[A]⁺ is a quaternary ammonium cation, an oxonium cation, a sulfonium cation or a phosphonium cation; and
[Y]ⁿ⁻ is a monovalent, divalent, trivalent or tetravalent anion;
or
the compounds of the formula II
[A¹]⁺[A²]⁺[Y]ⁿ⁻ (IIa),
where n=2;
[A¹]⁺[A²]⁺[A³]⁺[Y]ⁿ⁻ (IIb),
where n=3; or
[A¹]⁺[A²]⁺[A³]⁺[A⁴]⁺[Y]ⁿ⁻ (IIc),
where n=4,
where
[A¹]⁺, [A²]⁺, [A³]⁺ and [A⁴]⁺ are selected independently from among the groups mentioned for [A]⁺; and
[Y]ⁿ⁻ is as defined above.

6. The process according to claim 5, wherein [A]⁺ is a cation selected from among the compounds of the formulae (IIIa) to (IIIy) 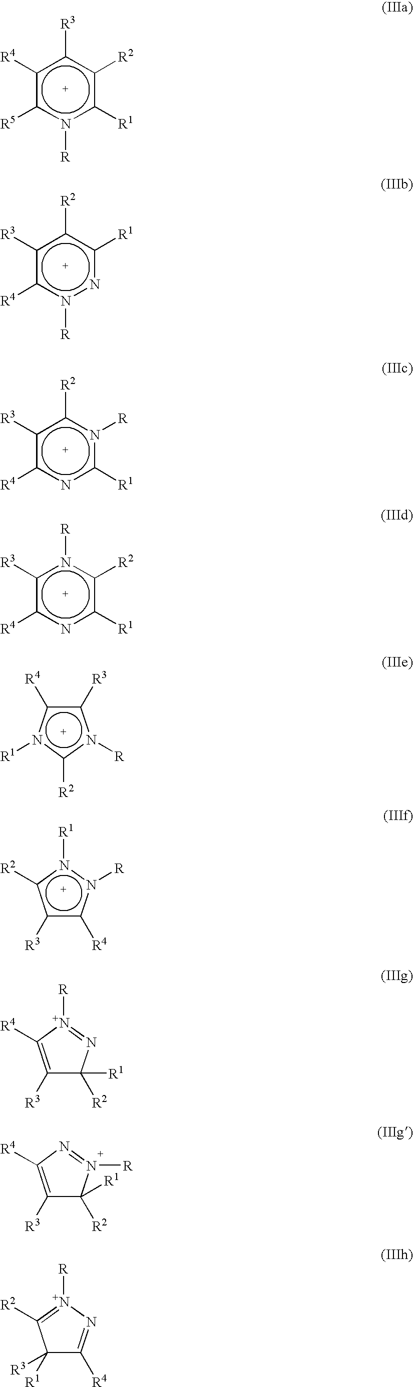 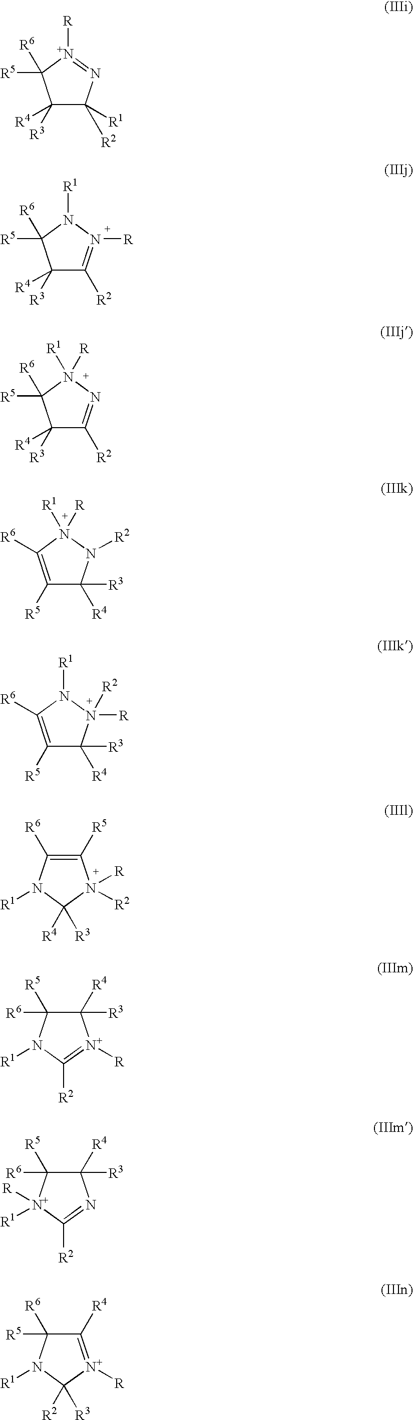 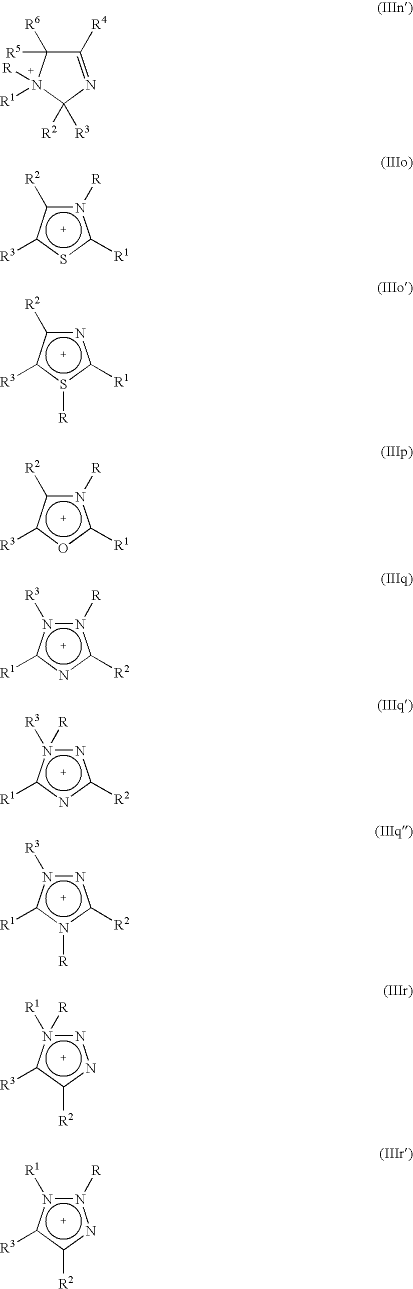 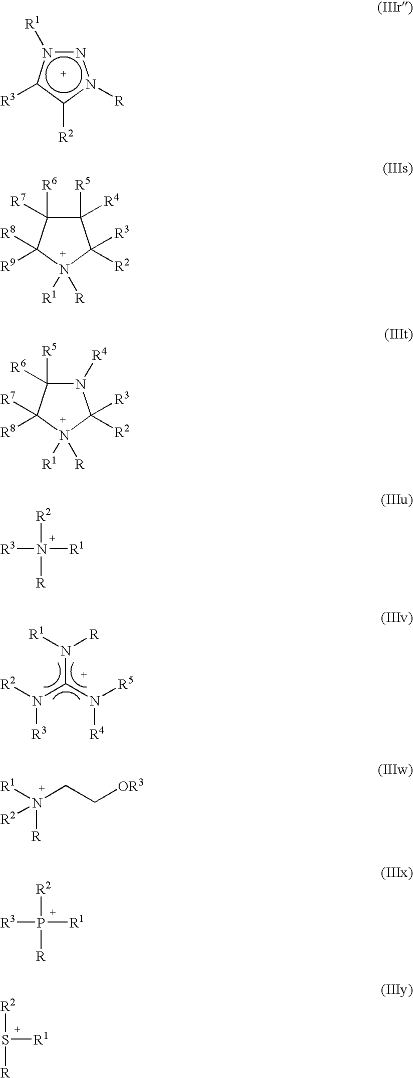
and oligomers comprising this structure, where
the radical R is hydrogen or a carbon-containing organic, saturated or unsaturated, acyclic or cyclic, aliphatic, aromatic or araliphatic radical which has from 1 to 20 carbon atoms and may be unsubstituted or be interrupted or substituted by from 1 to 5 heteroatoms or functional groups; and
the radicals R¹ to R⁹ are each, independently of one another, hydrogen, a sulfo group or a carbon-containing organic, saturated or unsaturated, acyclic or cyclic, aliphatic, aromatic or araliphatic radical which has from 1 to 20 carbon atoms and may be unsubstituted or be interrupted or substituted by from 1 to 5 heteroatoms or functional groups, where the radicals R¹ to R⁹ which are bound to a carbon atom (and not to a heteroatom) in the formulae (III) mentioned above are additionally able to be halogen or a functional group; or
two adjacent radicals from the group consisting of R¹ to R⁹ may together also form a divalent, carbon-containing organic, saturated or unsaturated, acyclic or cyclic, aliphatic, aromatic or araliphatic radical which has from 1 to 30 carbon atoms and may be unsubstituted or be interrupted or substituted by from 1 to 5 heteroatoms or functional groups.

7. The process according to claim 5, wherein [Y]ⁿ⁻ is an anion selected from
the group of halides and halogen-containing compounds of the formulae:
F⁻, Cl⁻, Br⁻, I⁻, BF₄⁻, PF₆⁻, CF₃SO₃⁻, (CF₃SO₃)₂N⁻, CF₃CO₂⁻, CCl₃CO₂⁻, CN⁻, SCN⁻, OCN⁻
the group of sulfates, sulfites and sulfonates of the general formulae:
SO₄²⁻, HSO₄⁻, SO₃²⁻, HSO₃⁻, R^{a}OSO₃⁻, R^{a}SO₃⁻
the group of phosphates of the general formulae
PO₄³⁻, HPO₄²⁻, H₂PO₄⁻, R^{a}PO₄²⁻, HR^{a}PO₄⁻, R^{a}R^{b}PO₄⁻
the group of phosphonates and phosphinates of the general formulae:
R^{a}HPO₃⁻, R^{a}R^{b}PO₂⁻, R^{a}R^{b}PO₃⁻
the group of phosphites of the general formulae:
PO₃³⁻, HPO₃²⁻, H₂PO₃⁻, R^{a}PO₃²⁻, R^{a}HPO₃⁻, R^{a}R^{b}PO₃⁻
the group of phosphonites and phosphinites of the general formulae:
R^{a}R^{b}PO₂⁻, R^{a}HPO₂⁻, R^{a}R^{b}PO⁻, R^{a}HPO⁻
the group of carboxylic acids of the general formula:
R^{a}COO⁻
the group of borates of the general formulae:
BO₃³⁻, HBO₃²⁻, H₂BO₃⁻, R^{a}R^{b}BO₃⁻, R^{a}HBO₃⁻, R^{a}BO₃²⁻, B(OR^{a})(OR^{b})(OR^{c})(OR^{d})⁻, B(HSO₄)^{-, B(R}^{a}SO₄)⁻
the group of boronates of the general formulae:
R^{a}BO₂²⁻, R^{a}R^{b}BO⁻
the group of silicates and silicic esters of the general formulae:
SiO₄⁴⁻, HSiO₄³⁻, H₂SiO₄²⁻, H₃SiO₄⁻, R^{a}SiO₄³⁻, R^{a}R^{b}SiO₄²⁻, R^{a}R^{b}R^{c}SiO₄⁻, HR^{a}SiO₄²⁻, H₂R^{a}SiO₄⁻, HR^{a}R^{b}SiO₄⁻
the group of alkylsilane and arylsilane salts of the general formulae:
R^{a}SiO₃³⁻, R^{a}R^{b}SiO₂²⁻, R^{a}R^{b}R^{c}SiO⁻, R^{a}R^{b}R^{c}SiO₃⁻, R^{a}R^{b}R^{c}SiO₂⁻, R^{a}R^{b}SiO₃²⁻
the group of carboximides, bis(sulfonyl)imides and sulfonylimides of the general formulae: 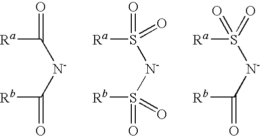
and the group of methides of the general formula: 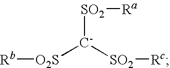
where the radicals R^{a}, R^{b}, R^{c} and R^{d} are each, independently of one another, hydrogen, C₁-C₃₀-alkyl, C₂-C₁₈-alkyl which may optionally be interrupted by one or more nonadjacent oxygen and/or sulfur atoms and/or one or more substituted or unsubstituted imino groups, C₆-C₁₄-aryl, C₅-C₁₂-cycloalkyl or a five- or six-membered, oxygen-, nitrogen- and/or sulfur-containing heterocycle, where two of them may also together form an unsaturated, saturated or aromatic ring which may optionally be interrupted by one or more oxygen and/or sulfur atoms and/or one or more unsubstituted or substituted imino groups, where the radicals mentioned may each be additionally substituted by functional groups, aryl, alkyl, aryloxy, alkyloxy, halogen, heteroatoms and/or heterocycles.

8. The process according to claim 5, wherein [A]⁺ is a cation selected from the group consisting of the compounds IIIa, IIIe, IIIf; IIIg, IIIg′, IIIh, IIIi, IIIj, IIIj′, IIIk, IIIk′, IIIl, IIIm, IIIm′, IIIn and IIIn′.

9. The process according to claim 5, wherein [A]⁺ is a cation selected from the group consisting of the compounds IIIa, IIIe and IIIf.

10. The process according to claim 5, wherein [Y]ⁿ⁻ is an anion selected from the group of halides and halogen-containing compounds, the group of carboxylic acids, the group consisting of SO₄²⁻, SO₃²⁻, R^{a}OSO₃⁻ and R^{a}SO₃⁻, and the group consisting of PO₄³⁻ and R^{a}R^{b}PO₄⁻.

11. The process according to claim 1, wherein the ketene comprises a ketene of the formula IVa or a diketene of the formula IVb1 or a mixed diketene of the formula IVb2, 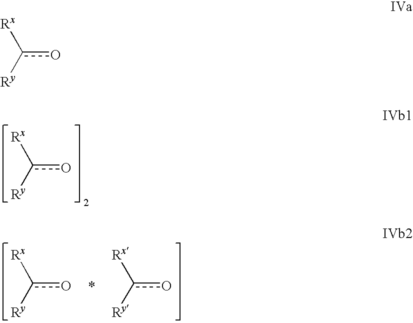
where the radicals have the following meanings:
R^{x}, R^{x′}, R^{y}, R^{y′} are each hydrogen, C₁-C₃₀-alkyl, C₂-C₃₀-alkenyl, C₂-C₃₀-alkynyl C₃-C₁₂-cycloalkyl, C₅-C₁₂-cycloalkenyl, aryl or heterocyclyl, where the latter seven radicals may optionally be substituted;
or
R^{x} and R^{y} or R^{x′} and R^{y′} together form an optionally substituted —Xₒ—(CH₂)ₚ—, —(CH₂)_{q}—X—(CH₂)ᵣ— or —CH═CH—CH═CH— chain, where
X is O, S, S(═O), S(═O)₂ or NR^{z};
R^{z} is hydrogen or C₁-C₆-alkyl;
o is 0 or 1;
p is 2, 3, 4, 5, 6, 7 or 8;
q, r are each 1, 2, 3, 4, 5 or 6.

12. The process according to claim 1, wherein a ketene of the formula IVa is reacted as ketene.

13. The process according to claim 1, wherein a diketene of the formula IVb1 is reacted as ketene.

14. The process according to claim 1, wherein a mixed diketene of the formula IVb2 is reacted as ketene.

15. The process according to claim 1, wherein the concentration of polysaccharide, oligosaccharide or disaccharide or derivative thereof in the ionic liquid is in the range from 0.1 to 50% by weight, based on the total weight of the solution.

16. The process according to claim 1, wherein the reaction is carried out at a temperature from the melting point of the ionic liquid up to 200° C.

17. The process according to claim 1, wherein the acylation of the polysaccharide is quenched by addition of a solvent in which the acylated polysaccharide is nonsoluble.

18. An acylated cellulose produced by a process according to claim 13.

19. A film, fiber or material comprising the acylated glucose according to claim 18.

20. An acylated cellulose produced by a process according to claim 14.

21. A film, fiber or material comprising the acylated glucose according to claim 20.
